(19) United States
(12) Patent Application Publication
(10) Pub. No.: US 2026/0261381 A1
(43) Pub. Date: Sep. 3, 2026

(54) NON-UNIFORM SENSING PATTERN CONFIGURATION

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 18/873,305

(22) PCT Filed: Aug. 2, 2022
(86) PCT No.: PCT/CN2022/109621

§ 371 Date: Dec. 9, 2024

(51) Int. Cl. H04L 5/00; H04B 7/06; H04W 56/00; H04W 72/231

(52) U.S. Cl. CPC H04L 5/0051; H04B 7/0626; H04B 7/06968; H04W 56/0015; H04W 72/231

(57) ABSTRACT

Apparatus, methods, and computer program products for sensing pattern configuration are provided. An example method may include configuring a periodic sensing reference signal (RS) configuration including a set of periodic sensing RS instances within a time window. The example method may further include configuring an aperiodic sensing RS configuration based on the periodic sensing RS configuration, where the aperiodic sensing RS configuration includes one or more aperiodic sensing RS instances within the time window. The example method may further include transmitting a first indication of the periodic sensing RS configuration and a second indication of the aperiodic sensing RS configuration for at least one wireless device.

### TECHNICAL FIELD

The present disclosure relates generally to communication systems, and more particularly, to wireless communication systems with sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a network entity are provided. The apparatus may include a memory and at least one processor coupled to the memory. The memory and the at least one processor coupled to the memory may be configured to configure a periodic sensing reference signal (RS) configuration including a set of periodic sensing RS instances within a time window. The memory and the at least one processor coupled to the memory may be further configured to configure an aperiodic sensing RS configuration based on the periodic sensing RS configuration, where the aperiodic sensing RS configuration includes one or more aperiodic sensing RS instances within the time window. The memory and the at least one processor coupled to the memory may be further configured to transmit a first indication of the periodic sensing RS configuration and a second indication of the aperiodic sensing RS configuration for at least one wireless device.

In another aspect of the disclosure, a method, a computer-readable medium, and an apparatus at a wireless device are provided. The apparatus may include a memory and at least one processor coupled to the memory. The memory and the at least one processor coupled to the memory may be configured to receive a first indication of a periodic sensing reference signal (RS) configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. The memory and the at least one processor coupled to the memory may be further configured to monitor for a plurality of signals within the time window based on the periodic sensing RS configuration and the aperiodic sensing RS configuration.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example Doppler granularity.

FIG. 5 is a diagram illustrating example phase continuity in Doppler estimation.

FIG. 6 is a diagram illustrating example sensing observation windows.

FIG. 7 is a diagram illustrating example communications between a network entity and a wireless device.

FIG. 8 is a diagram illustrating example sensing RSs.

FIG. 9 is a diagram illustrating example sensing RSs.

FIG. 10 is a diagram illustrating example sensing RSs.

FIG. 11 is a diagram illustrating example sensing RSs.

FIG. 12 is a diagram illustrating example sensing RSs.

FIG. 13 is a diagram illustrating example sensing RSs.

FIG. 14 is a diagram illustrating example sensing RSs.

FIG. 15 is a diagram illustrating example communications between devices for sensing.

FIG. 16 is a diagram illustrating example communications between devices for sensing.

FIG. 17 is a diagram illustrating example communications between devices for sensing.

FIG. 18 is a diagram illustrating example communications between devices for sensing.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a diagram illustrating an example of a hardware implementation for an example apparatus and/or network entity.

FIG. 24 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

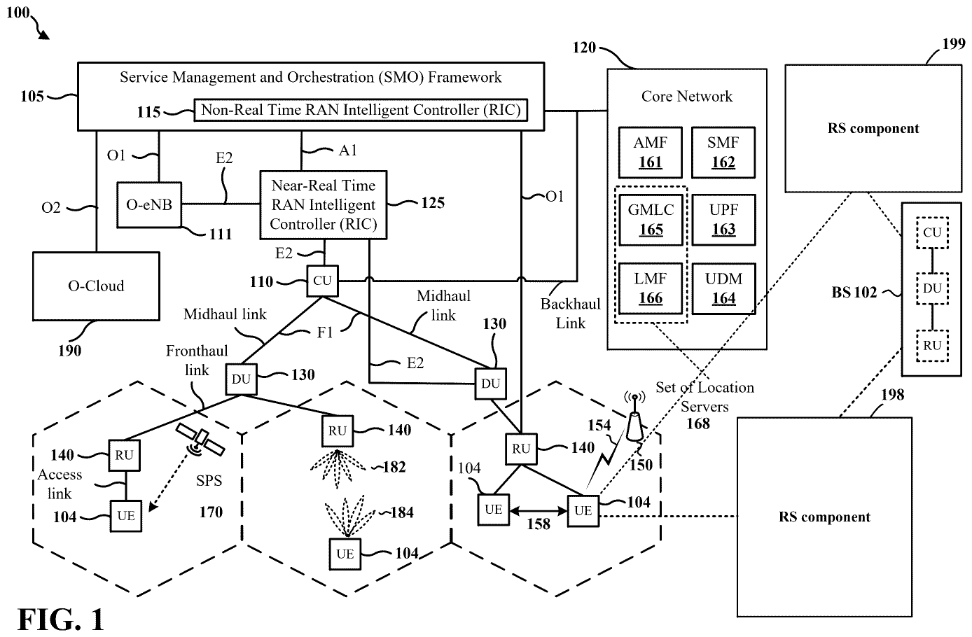

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include an RS component 198. In some aspects, the RS component 198 may be configured to receive a first indication of a periodic sensing reference signal (RS) configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. In some aspects, the RS component 198 may be further configured to monitor for a plurality of signals within the time window based on the periodic sensing RS configuration and the aperiodic sensing RS configuration.

In certain aspects, the base station 102 may include an RS component 199. In some aspects, the RS component 199 may be configured to configure a periodic sensing reference signal (RS) configuration including a set of periodic sensing RS instances within a time window. In some aspects, the RS component 199 may be further configured to configure an aperiodic sensing RS configuration based on the periodic sensing RS configuration, where the aperiodic sensing RS configuration includes one or more aperiodic sensing RS instances within the time window. In some aspects, the RS component 199 may be further configured to transmit a first indication of the periodic sensing RS configuration and a second indication of the aperiodic sensing RS configuration for at least one wireless device.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

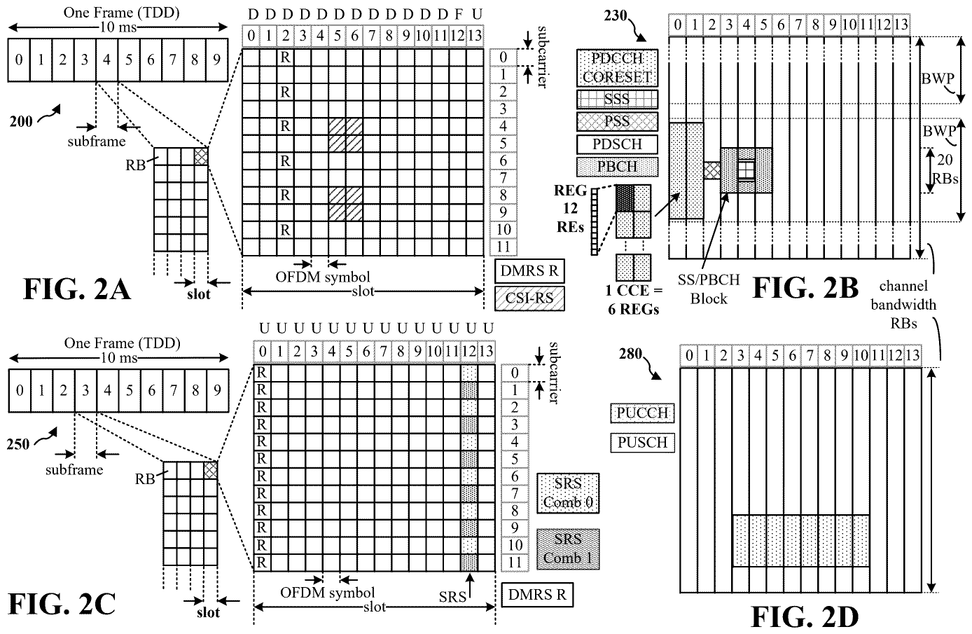

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

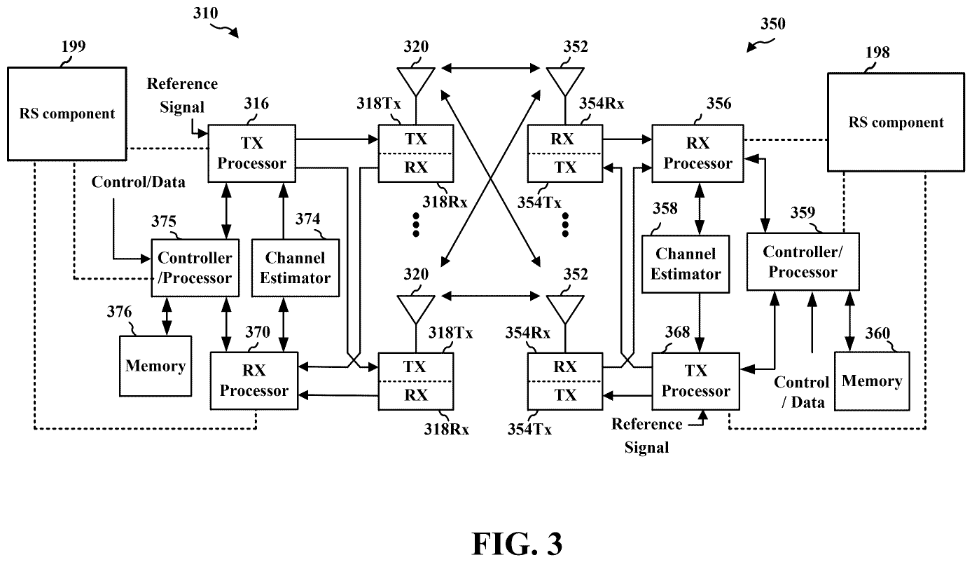

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RS component 198 of FIG. 1.

At least one of the TX processor 316, the RX processor 370, and the controller/processor 375 may be configured to perform aspects in connection with RS component 199 of FIG. 1.

In some aspects of wireless communication, speed estimation may be a function enabled by sensing in a wireless communication system. For example, speed may be estimated based on Doppler estimation. An example equation

$$d = \frac{v}{λ} cos θ$$

may show example Doppler estimation and speed. In the example equation, the parameter v is the speed of the target, the parameter d is the Doppler information, the parameter λ is the wavelength, the parameter θ is the angle between the direction of motion and the direction of the waves. Based on measuring the Doppler information using a signal of a known wavelength and angle, the speed may be estimated. Such speed estimation may be used for detection of a moving object (e.g., an automobile or a pedestrian). In the sensing, the performance of the Doppler estimation is based on a Doppler granularity and an estimation accuracy. Doppler granularity may be based on the equation λ/2 T. The parameter λ is the wavelength and the parameter T is the duration of an observation window (i.e., how long the Doppler effect of the target of interest is analyzed), which may also be referred to as “sensing observation window” or “sensing window.” The Doppler granularity is proportional to the wavelength λ and the observation window T. If the wavelength A is fixed, to achieve a higher granularity, a larger observation window T may be used. The estimation accuracy may be partially determined by the signal-to-noise ratio (SNR) or signal-to-interference and noise ratio (SINR) of the received signals (the signals for the Doppler estimation). For example, a high channel quality may result in a more accurate estimation. High density of the sensing, e.g., repetition of the sensing RS, may also improve the SNR to obtain a high accuracy.

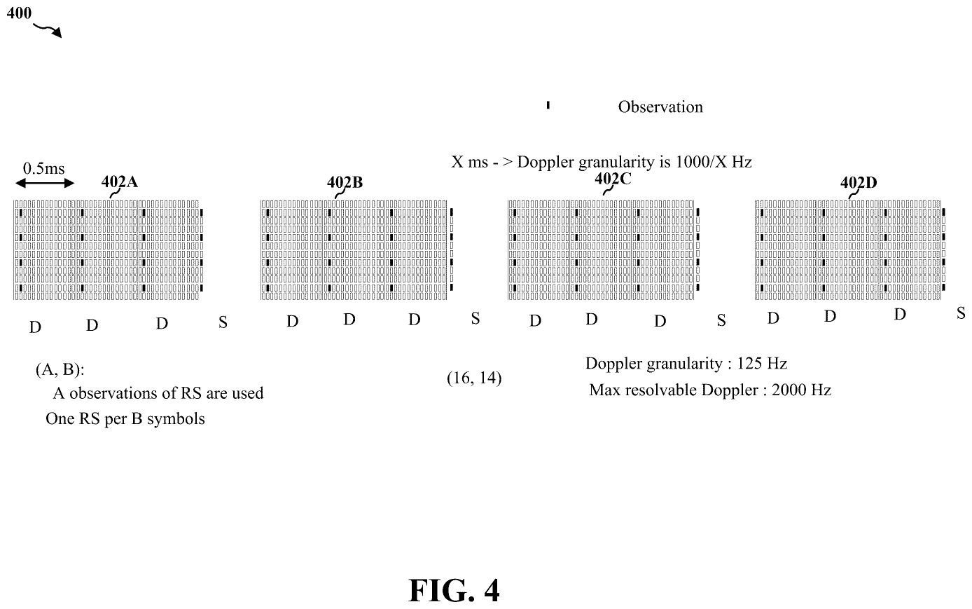

FIG. 4 is a diagram 400 illustrating an example Doppler granularity. As illustrated in FIG. 4, there may be sixteen observations in a time window 402A, a time window 402B, a time window 402C, or a time window 402D. The duration of each of the time window 402A, the time window 402B, the time window 402C, or the time window 402D may be 1.5 milliseconds (ms). With a 3.5 GHz carrier (with wavelength of roughly 0.086 m) of the signal for measurement, a speed granularity may be about 10 m/s with the 3.5 GHz carrier. The granularity may be low and it may be difficult to identify a pedestrian with a different moving speed. One potential way of improving the granularity may be to deploy the sensing in a higher band, e.g., a millimeter wave (mmW) band, or configure a longer observation window for the estimation.

With a longer configured observation window T, determining a phase continuity of two adjacent transmitted sensing waveforms may be a challenge. For two sensing resources, a same phase variation pattern φ(t) may be followed. In the window T, an Rx side of the signal may extract the phase variation pattern from multiple sensing instances. The Rx side may differentiate the Doppler to obtain the Doppler shift, such as by comparing the phase variation between Tx and Rx, as shown in the equation

$$f = \frac{1}{2 π} \frac{d}{dt} φ ( t ) .$$

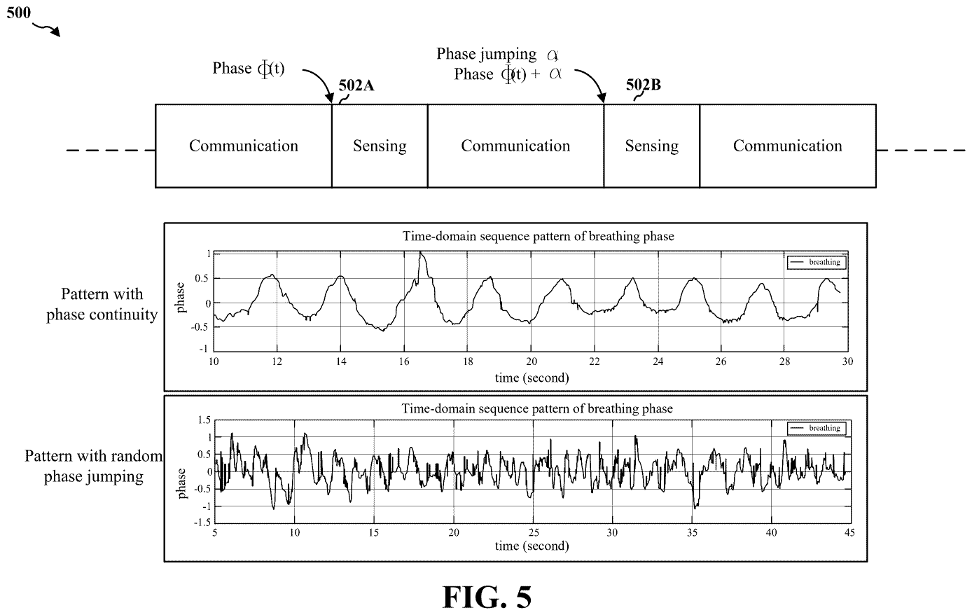

However, there may be an unknown phase jump α, which may interfere with the derived Doppler shift. FIG. 5 is a diagram 500 illustrating an example phase continuity in Doppler estimation. As illustrated in FIG. 5, there may be a phase jumping α between a first sensing instance 502A and a second sensing instance 502B. Such unknown phase jumping may lead to chaos in the extracted phase pattern on the receiving end. Such phase jumping may cause partial phase discontinuity and may degrade the accuracy of the Doppler estimation.

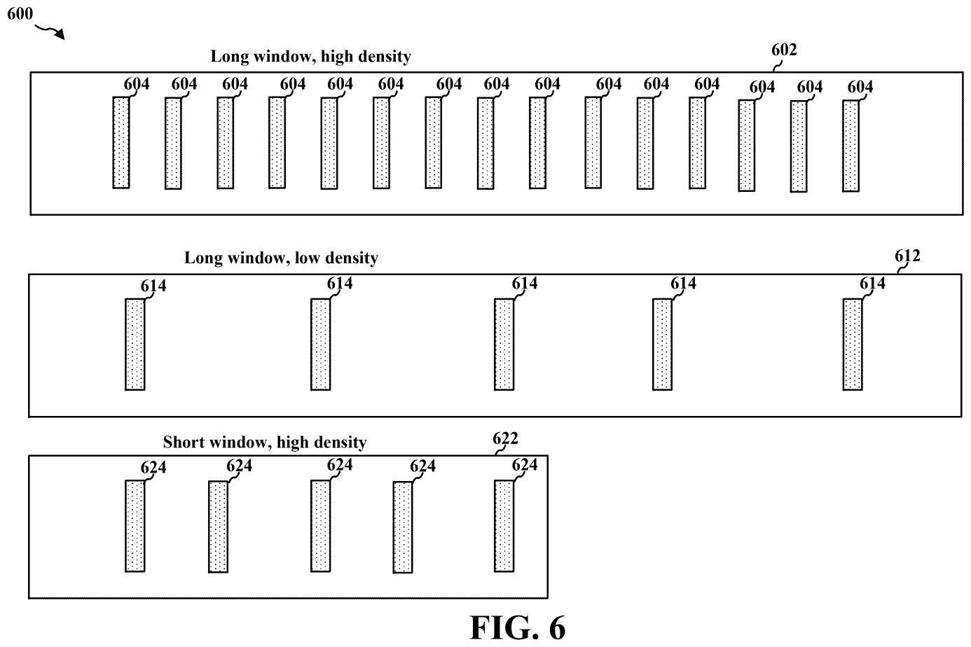

Because the Doppler granularity may depend on a duration of the observation window T and the density of the RS may affect the accuracy of the Doppler estimation, a more accurate speed estimation may be associated with a larger consumption of resources (e.g., time and frequency resources and processing resources of the RSs). FIG. 6 is a diagram 600 illustrating example observation windows and RSs. As illustrated in FIG. 6, the observation window 602 may be long and may include a set of high density RSs 604. The observation window 612 may be long and may include a set of low density RSs 614. The observation window 622 may be short and may include a set of high density RSs 624. Depending on the specific usage of the sensing (e.g., different services, applications, or the like), different observation windows and different density of RSs may be used. One sensing setting (e.g., one customer premises equipment (CPE) at home) may be enabled for different services, and each service may be associated with one specific Doppler granularity specification. For example, one CPE may provide the sensing services including: the pedestrian counting, health monitoring, or body/hands detections. If the sensing is for human actions, e.g., body or hands, the Doppler granularity may be relatively high, and the latency may be relaxed. If the sensing is for flight monitoring, the sensing may include a low Doppler granularity and a strict latency specification. Therefore, for sensing for flight monitoring, faster processing with a lower Doppler granularity may be used. For sensing for human actions, slower processing with a higher Doppler granularity may be used. Aspects provided herein may provide a quick and efficient sensing configuration such that different sensing services with different Doppler granularities may be efficiently supported. For example, aspects provided herein may enable a flexible sensing resource configuration for service switching with a low signaling overhead. Aspects provided herein may use a flexible sensing resource configuration with a non-uniform pattern of RSs, enabling improved performance (e.g., latency and accuracy performance) for different sensing services. Such non-uniform patterns may enable a high sensitivity, ambiguity elimination, and a strong resistance to countermeasures and interception. Aspects provided herein may also decrease resource usage associated with sensing operations.

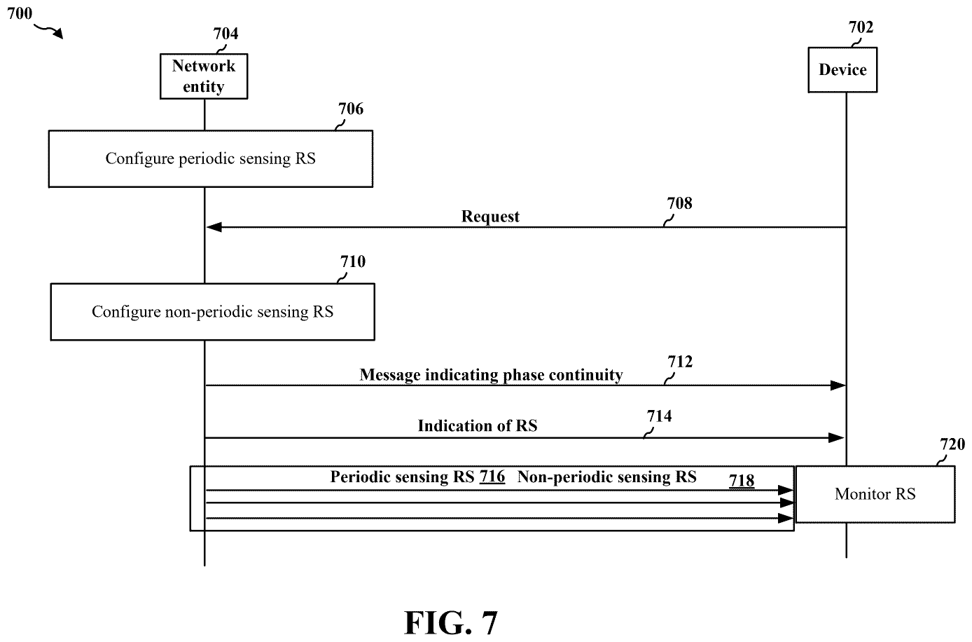

FIG. 7 is a diagram 700 illustrating example communications between a network entity 704 and a wireless device 702. The network entity 704 may be a network node. In some aspects, the network entity 704 may be a UE. In some aspects, the wireless device 702 may be a UE or a network entity. In some aspects, the network entity may be a base station that may be implemented as an aggregated base station, as a disaggregated base station, an integrated access and backhaul (IAB) node, a relay node, a sidelink node, or the like. A network entity may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. As used herein, the term “aperiodic” may be used interchangeably with the term “non-periodic.”

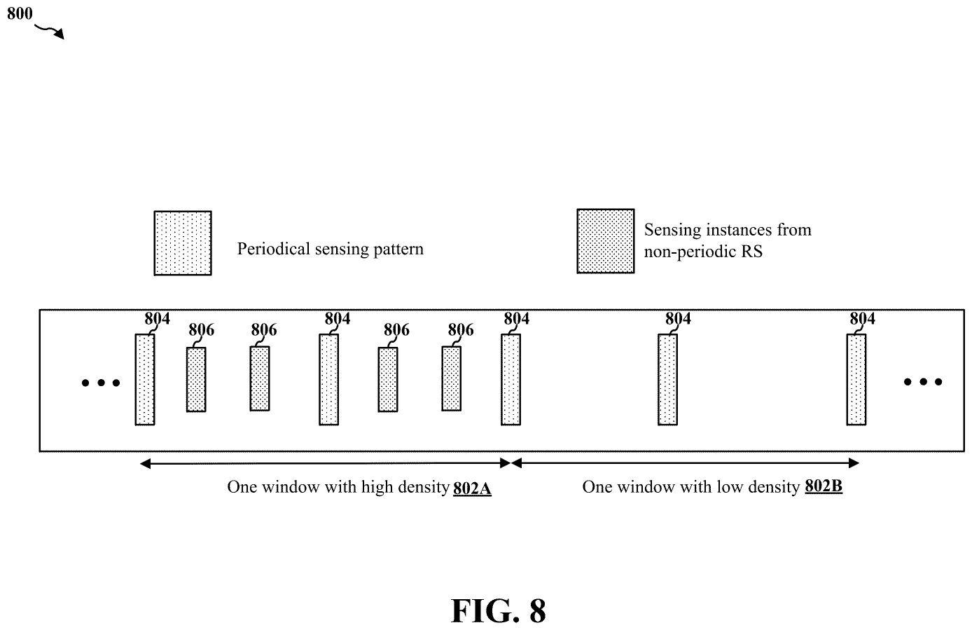

As illustrated in FIG. 7, at 706, the network entity 704 may configure a set of periodic sensing RS 716. The time instances in which the set of periodic sensing RS 716 are transmitted may be referred to as “periodic sensing RS instances.” At 710, the network entity 704 may configure a set of non-periodic sensing RS 718. The time instances in which the set of non-periodic sensing RS 718 are transmitted may be referred to as “non-periodic sensing RS instances.” In some aspects, the network entity 704 may transmit indication(s) 714 of the set of non-periodic sensing RS 718 and the set of periodic sensing RS 716 to the wireless device 702. Details regarding the set of periodic sensing RS and the set of non-periodic sensing RS may be discussed in more detail in connection with FIGS. 8-14. The network entity 704 may transmit the set of periodic sensing RS 716 configured at 706 and the set of periodic sensing RS 718 configured at 710 to the wireless device 702. In some aspects, the wireless device 702 may monitor the set of periodic sensing RS 718 and the set of periodic sensing RS 716 at 720. In some aspects, the set of periodic sensing RS and the set of non-periodic sensing RS may be based on a sensing RS configuration. Based on the sensing RS configuration, the RSs may be configured as either periodic, aperiodic, or both periodic and aperiodic. In some aspects, the set of periodic sensing RS 716 configured at 706 may include resources with a same periodicity and a bandwidth in all occurrences of the set of periodic sensing RS. As an example, the periodicity may be one of {10 ms, 20 ms, 40 ms, 80 ms, or any other appropriate time period}. Such a high periodicity (with a sparse pattern) may provide a long observation window and may be associated with a high resolution of the Doppler estimation. However, the accuracy may be low including a low SNR. The set of non-periodic sensing RS 718 configured at 710 may provide additional instances for the periodic sensing RS. In some aspects, the set of non-periodic sensing RS 718 configured at 710 may be triggered dynamically outside of the periodically occurring occasions. Therefore, the set of periodic sensing RS may include a sparse pattern, which may be supplemented with the set of non-periodic sensing RS on demand when high density measurement would be used for high accuracy. For example, one sparse periodical pattern may be configured for the long window observation and one aperiodic RS may be indicated to add the additional instances in one-time duration, e.g., one observation window T. Therefore, the sparse periodical pattern may be dynamically enhanced with a high density. Referring to FIG. 8, diagram 800 illustrates example sensing RSs. As illustrated in FIG. 8, in a first observation window 802A, the set of periodic sensing RS 804 and the set of non-periodic sensing RS 806 may be configured. In a second observation window 802B, the set of periodic sensing RS 804 may be configured and the set of non-periodic sensing RS 806 may be not configured.

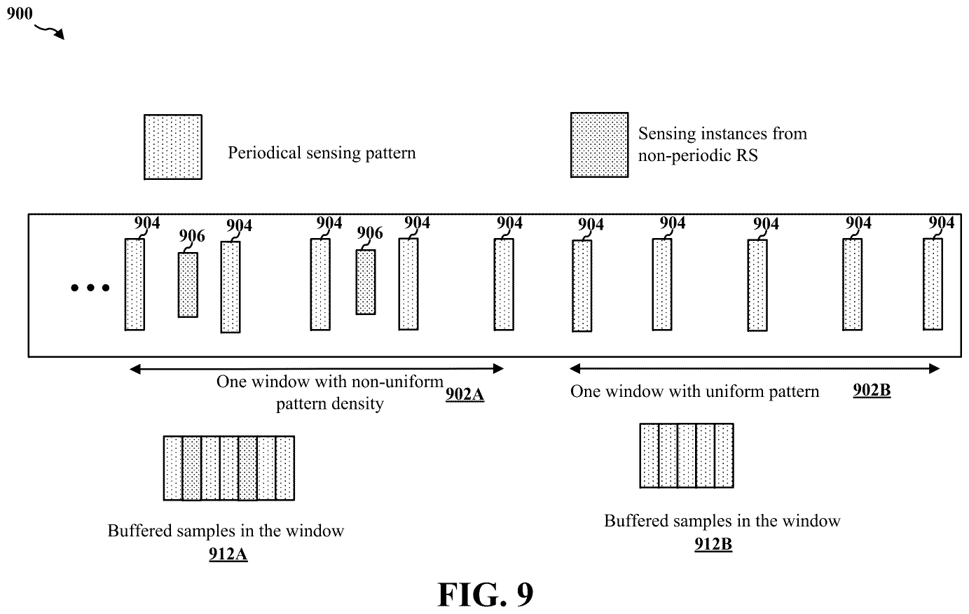

In some aspects, the set of non-periodic sensing RS 718 configured at 710 and the set of periodic sensing RS 716 configured at 706 may be associated with one another based on an association. In some aspects, the association may be based on network control (e.g., by the network entity 704). In some aspects, the set of non-periodic sensing RS 718 configured at 710 may be dynamically configured when different sensing applications, services, or scenarios are enabled for the device 702. In some aspects, the set of non-periodic sensing RS 718 configured at 710 may be configured based on downlink control information (DCI) in the indication 714 and the device 702 may receive and buffer the set of non-periodic sensing RS. Referring to FIG. 9, diagram 900 illustrates example sensing RSs. As illustrated in FIG. 9, in a first observation window 902A, the set of periodic sensing RS 904 and the set of non-periodic sensing RS 906 may be configured. In a second observation window 902B, the set of periodic sensing RS 904 may be configured and the set of non-periodic sensing RS 906 may be not configured. The device 702 may buffer samples 912A in the observation window 902A, which may include buffers of the set of periodic sensing RS 904 and the set of non-periodic sensing RS 906. The device 702 may buffer samples 912B in the observation window 902B, which may include buffers of the set of periodic sensing RS 904.

In some aspects, the set of non-periodic sensing RS 718 configured at 710 may be configured based on a request 708 from the wireless device 702. The request 708 may be an on-demand request of aperiodic RS to a single Tx (or multiple Tx). In some aspects, the wireless device 702 may transmit the request 708 to indicate an enhancement on resource density for one observation window without explicitly indicating the aperiodic RS (without explicitly indicating the set of non-periodic sensing RS 718). For example, the request 708 may indicate a request of additional sensing instances of a certain quantity in a cycle (e.g., in an observation window) without explicitly indicating a time or index associated with the additional sensing instances. In some aspects, the wireless device 702 may transmit the request 708 which may explicitly indicate the aperiodic RS (e.g., the set of non-periodic sensing RS 718) to be associated with an observation (and associated periodic sensing RS). In some aspects, the request 708 may include an aperiodic resource index associated with the set of non-periodic sensing RS 718, and the network entity 704 may configure the set of non-periodic sensing RS 718 based on the aperiodic resource index accordingly at 710.

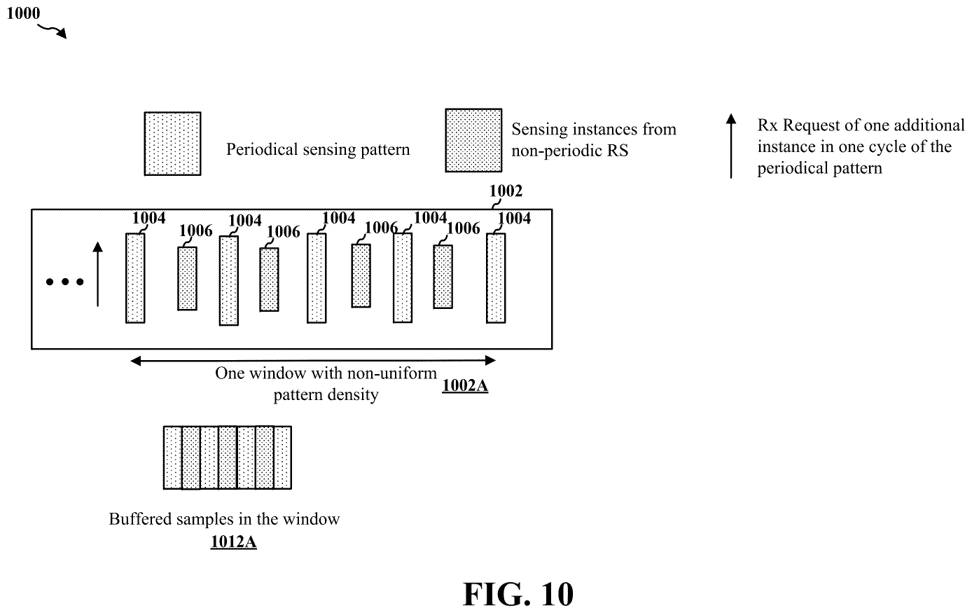

Referring to FIG. 10, diagram 1000 illustrates example sensing RSs. As illustrated in FIG. 10, a request of one additional instance in one cycle of the periodical pattern associated with the set of periodic sensing RS 1004 for an observation window 1002A may be received by the network entity 704. Accordingly, the network entity 704 may configure a set of non-periodic sensing RS 1006. A quantity of RS in the set of non-periodic sensing RS 1006 may be equal to a quantity of RS in the set of periodic sensing RS 1004 based on the request. The wireless device 1002 may buffer the samples 1012A of the set of periodic sensing RS 1004 and the set of non-periodic sensing RS 1006.

In some aspects, the set of non-periodic sensing RS 718 may be associated with one or more specific periodical patterns associated with the set of periodic sensing RS 716. The one or more specific periodical patterns may be associated with one or multiple aperiodic RS (in the set of non-periodic sensing RS 718). In some aspects, one aperiodic RS may be based on a channel state or accuracy request. For example, one aperiodic RS with a high density may be configured for a low SNR scenario or a high accuracy request (e.g., which may be part of the request 708) in one sensing service (e.g., of the wireless device 702). In some aspects, an aperiodic sensing instance (in the set of non-periodic sensing RS 718) may be transmitted if the associated periodic sensing RS (e.g., in the set of periodic sensing RS 716) is configured, but not if the associated periodic sensing RS is not configured. In some aspects, groups of aperiodic sensing RS (e.g., in the set of non-periodic sensing RS 718) may be configured to be associated with one or more periodical sensing patterns (e.g., of the set of periodic sensing RS 716).

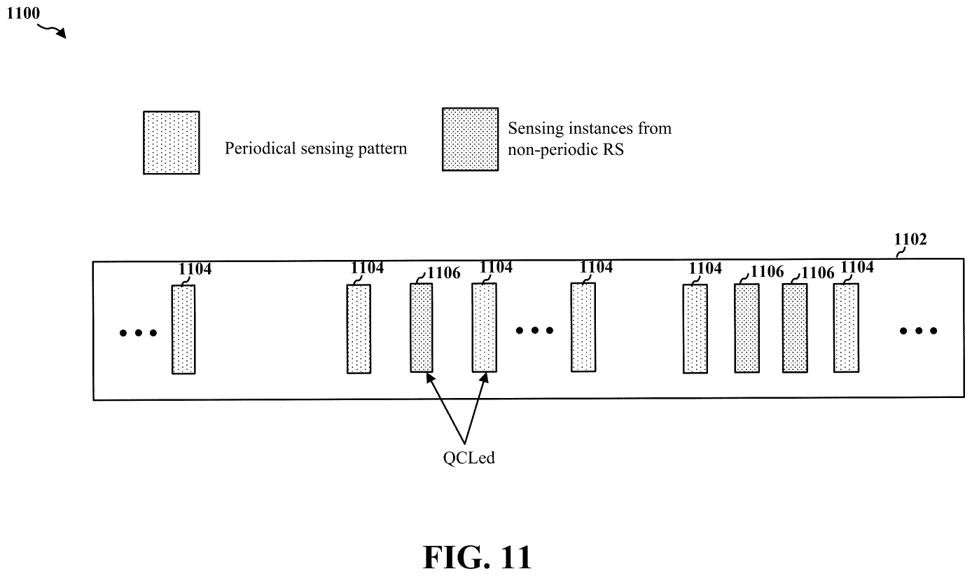

In some aspects, if there is phase continuity, two resources may be combined as one resource for the Doppler estimation. If the phase is discontinued (e.g., with non-phase continuity), the latter RS may be discarded for the Doppler estimation. As used herein, the term “non-phase continuity” may refer to no phase continuity. In some aspects, there may be phase continuity between the set of periodic sensing RS 716 and the set of non-periodic sensing RS 718. Signaling may be used for indicating the phase continuity between the set of periodic sensing RS 716 and the set of non-periodic sensing RS 718. In some aspects, one or more quasi-co-location (QCL) types may be used for indicating the phase continuity. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). One or more of the QCL type A, QCL type B, QCL type C, or the QCL type D may also include phase continuity and may be used for indicating phase continuity. Additionally or alternatively, a QCL type different from the QCL type A, QCL type B, QCL type C, or the QCL type D may include phase continuity and may be used for indicating phase continuity. Referring to FIG. 11, diagram 1100 illustrates example sensing RSs. As illustrated in FIG. 11, in an observation window 1102, there may be a set of periodic sensing RS 1104 and a set of non-periodic sensing RS 1106. The set of periodic sensing RS 1104 and the set of non-periodic sensing RS 1106 may have phase continuity and may be quasi-co-located (QCLed) based on the QCL type that includes phase continuity.

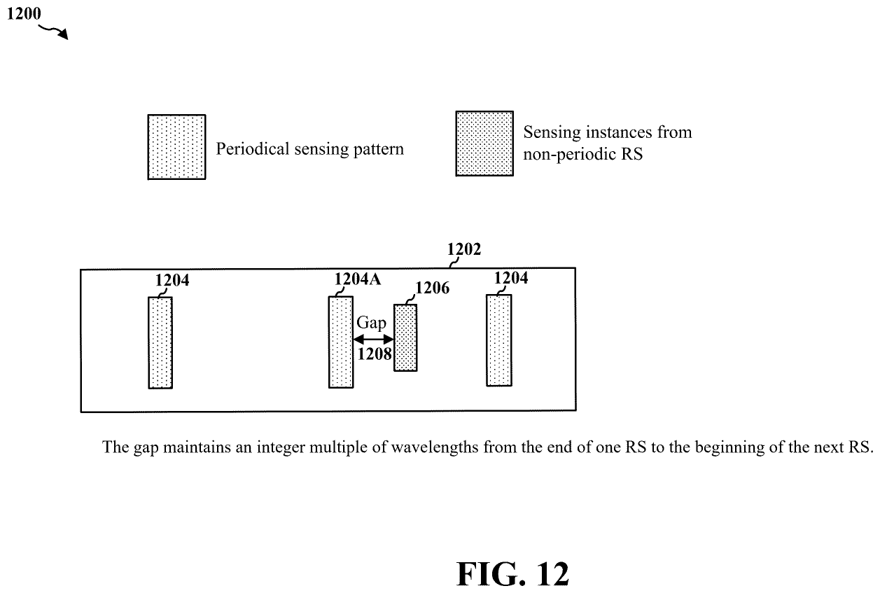

In some aspects, a message 712 may be used for indicating phase continuity between the set of periodic sensing RS 716 and the set of non-periodic sensing RS 718. In some aspects, the message 712 may include 1 bit for indicating whether there is phase continuity (e.g., 0 or 1 indicating phase continuity while the other of 0 or 1 indicates non-phase continuity). In some aspects, the message 712 may include a phase variation compared to the end of the latest sensing instance. After the wireless device 702 receives the phase variation, the wireless device 702 may compensate the phase of the received RS based on the phase variation to create the phase continuity at the receiver of the wireless device 702. Referring to FIG. 12, diagram 1200 illustrates example sensing RSs. As illustrated in FIG. 12, in an observation window 1202, there may be a set of periodic sensing RS 1204 and a set of non-periodic sensing RS 1206. A gap 1208 between one instance 1204A of the set of periodic sensing RS 1204 and a non-periodic sensing RS 1206 may maintain an integer multiple of wavelengths from the end of one RS to the beginning of the next RS. A phase variation between the non-periodic sensing RS 1206 and the instance 1204A may be known to the wireless device 702 and may be compensated accordingly.

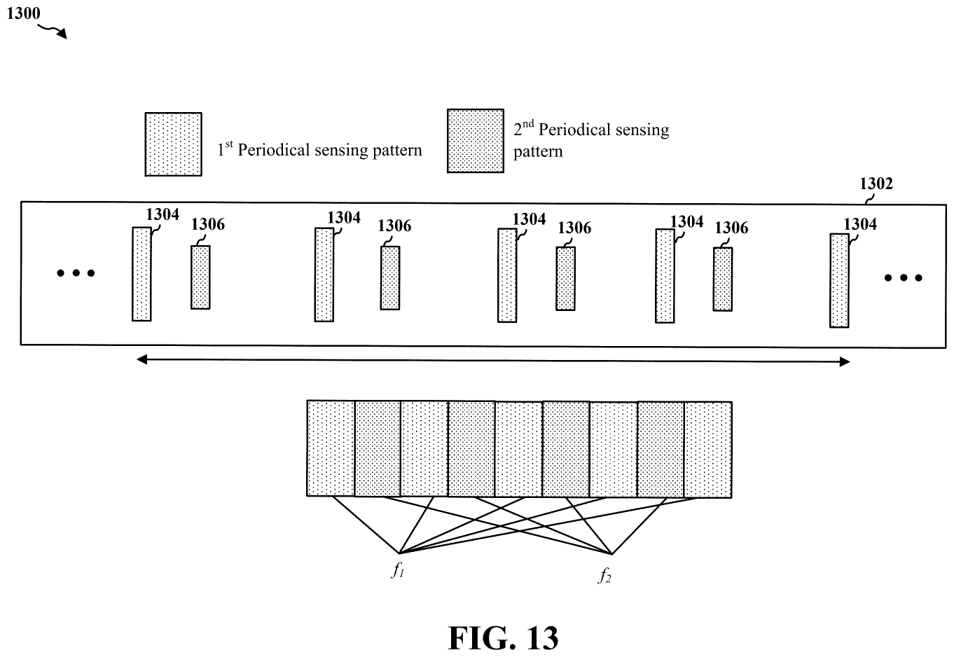

In some aspects, two or more sensing RS (e.g., in the set of periodic sensing RS 716) with periodical patterns may be associated or combined for the Doppler estimation. For example, the set of periodic sensing RS 716 may include two subsets of periodic sensing RS with different configurations (e.g., different pattern which may include different periodicity or different frequency, or other differences). In some aspects, the two subsets of periodic sensing RS may have phase continuity. In some aspects, there may be a signaling to indicate the phase continuity between the two subsets of periodic sensing RS. In some aspects, based on the phase continuity, the two subsets of periodic sensing RS may be combined as one set of sensing RS with high density. In some aspects, if there is non-phase continuity between the two subsets of periodic sensing RS, the wireless device 702 may still buffer the two subsets of periodic sensing RS. Referring to FIG. 13, diagram 1300 illustrates example sensing RSs. As illustrated in FIG. 13, in an observation window 1302, there may be a first subset of periodic sensing RS 1304 and a second subset of periodic sensing RS 1306. A receiver of the first subset of periodic sensing RS 1304 and the second subset of periodic sensing RS 1306 (such as the wireless device 702), may separately measure the Doppler shifts for two frequency resources, f₁ and f₂, of the two subsets of periodic sensing RS. The wireless device 702 may average the frequencies f₁ and f₂ or implement other mechanisms for combining the frequencies f₁ and f₂ (such as weighting based on periodicity or the like).

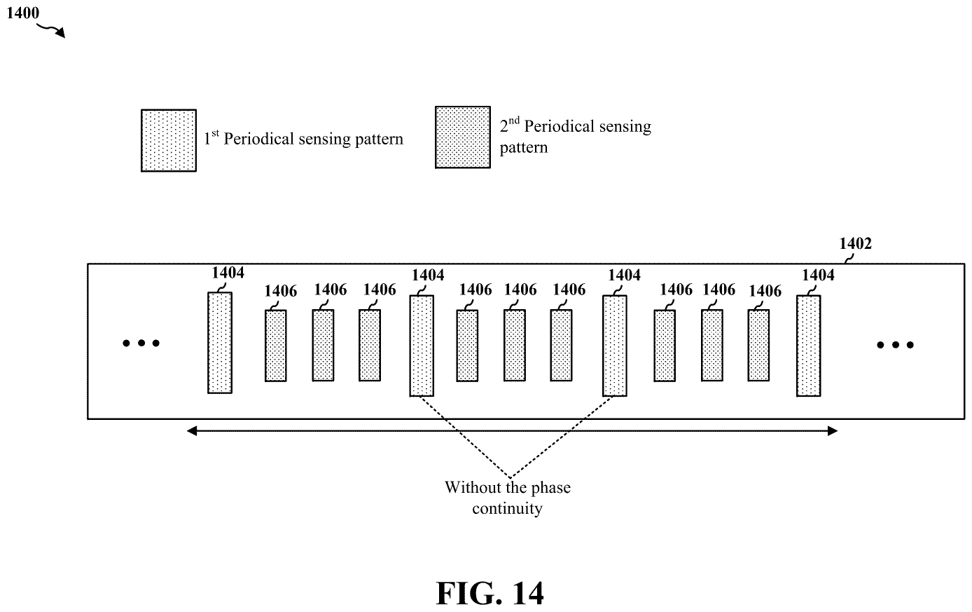

In some aspects, one channel may be associated with one sensing RS (e.g., a first subset of periodic sensing RS or the non-periodic sensing RS) to enhance the Doppler estimation. For example, if the network entity 704 is a base station, the channel may be one of a channel state information reference signal (CSI-RS), a synchronization signal block (SSB), a positioning reference signal (PRS), or a tracking reference signal (TRS). If the network entity 704 is a UE, the channel may be one of an SRS or a PRS. In some aspects, the channel and sensing RS can be combined as one resource (e.g., in the set of periodic sensing RS 716) for the Rx estimation (e.g., at the wireless device 702). In some aspects, if sensing RS for a channel is with an aperiodic resource (e.g., part of the set of non-periodic sensing RS 718), a signaling (e.g., message 712) may indicate the phase continuity between the instance of the channel and the associated sensing RS. In some aspects, if sensing RS for a channel is with periodic resource (e.g., part of the set of periodic sensing RS 716), the channel may be for data transmission and there may be non-phase continuity between different subsets of periodic sensing RS. Referring to FIG. 14, diagram 1400 illustrates example sensing RSs. As illustrated in FIG. 14, within an observation window 1402, there may be a first set of non-periodic sensing RS 1404 and a second set of non-periodic sensing RS 1406. There may be non-phase continuity between the first set of non-periodic sensing RS 1404 and the second set of non-periodic sensing RS 1406.

Some aspects provided herein may provide adaptive sensing signal transmission from a UE-based sensing device without full duplex capability. For example, two or more UEs may be involved in the bi-static or multi-static sensing. Object detection may rely on the sensing device to transmit sensing signals and detect changes in the received signal that indicates the presence of an object. Dense transmission of sensing signals with a long duration and phase continuity may result in better detection performance of the object. However, for the purpose of saving power on the sensing device, adaptive transmission of the sensing signal may be provided. Before any object is present, sensing device may transmit low cost (e.g., short duration, on sparse occasions) sensing signals for object detection. Once an object is detected (accuracy of direction, location and speed is not important at this phase), a sensing device may switch to transmit a higher cost (e.g., long duration, long duration, with phase continuity) sensing signal for more accurate object detection and tracking. After the object leaves, the sensing device may restore the low-cost sensing signal transmission to save power. In some instances, the adaptive transmission of sensing signal may not be controlled by network even when sensing devices are within the coverage range of cellular network because a base station may not be able to detect the object in a timely manner due to blocking or a bad geometric relationship with the object. Besides, transmitting a sensing signal on a cell level may not be feasible due to the limited cell level resource shared with communication and transmitting sensing signals on a cell level may generate interference to neighboring cells. Therefore, a local sensing activity with a relatively low power sensing signal transmission by UEs may be more efficient.

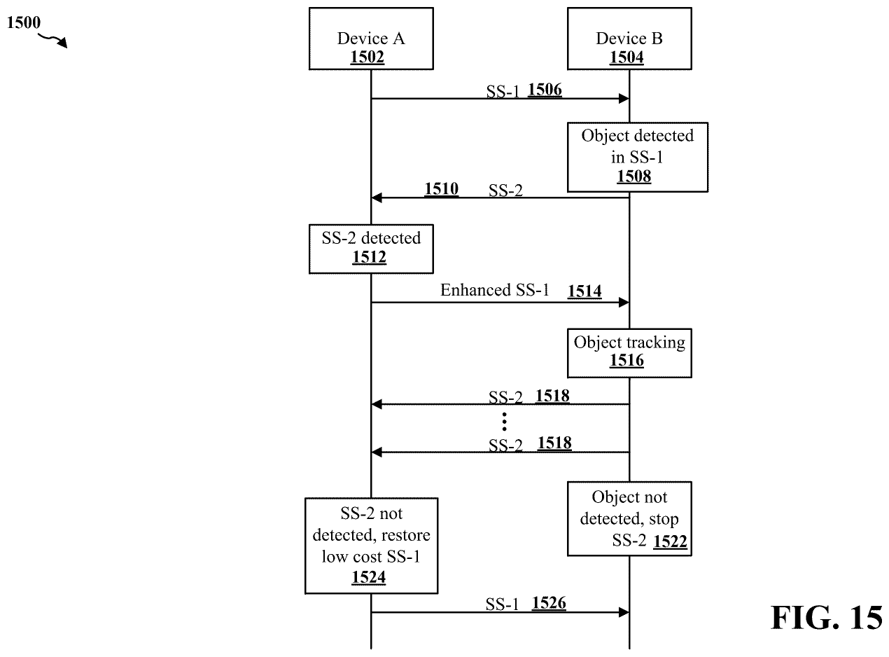

In an example frame provided herein, adaptation of sensing signal transmission may be realized by over-the-air (OTA) mechanisms. FIG. 15 is a diagram 1500 illustrating example communications between devices for sensing. At step 1, sensing device A 1502 may transmit sensing signal SS-1 1506 to device B 1504. In some aspects, SS-1 may be low cost e.g., transmitted on sparse occasions. On each occasion, the duration may be short if the presence of an object may be detected by SS-1. If mobility and speed of the object are detected, the SS-1 duration may be relatively longer with a phase continuity for micro-Doppler detection. Based on the object detected in SS-1 at 1508, the sensing device B 1504 may start to transmit SS-2 1510. The detection may be claimed when device B starts to receive SS-1, starts to detect a change in amplitude or new multi-path component of the received SS-1, or starts to detect micro-Doppler in the received SS-1. SS-2 may be transmitted with a fixed time offset to the SS-1 occasion. For example, SS-2 may be also low cost, e.g., sparse and with a short duration, and may act as an indicator signal. In another example, SS-2 may be an enhanced sensing signal, e.g., dense and with a long duration. Then device A may also carry out the sensing computation based on SS-2. At 1512, the sensing device A may detect SS-2 and may switch to a tracking mode. Device A may switch to transit the enhanced SS-1 1514, e.g., in shorter periodicity, wider bandwidth, narrower beam (potentially with beam sweeping and refinement), with phase continuity and/or with a long duration on each duration. In some aspects, the sensing device B 1504 may carry out a sensing computation and track the object at 1516. The device B may keep transmitting SS-2 1518. In some aspects, the sensing object may leave the detection range of the sensing devices. The device B may not detect the object in SS-1 anymore and it may stop transmitting SS-2 at 1522. In some aspects, device A may not receive SS-2 anymore (or alternatively it may not detect the object in SS-2 when enhanced SS-2 is transmitted) at 1524, and the device A may switch to low-cost SS-1 1526.

If object is detected based on SS-1 being received by device B, after the object leaves, SS-2 may disappear even if device B still transmits it. If the object is detected based on micro-Doppler being detected in SS-1 by device B, after the object leaves, SS-2 may still be received by device A (due to direct path or environmental reflection). Device B may turn off SS-2 transmission. In either case, once device B turns off SS-2 transmission after the object is gone, device A may know it can switch to low-cost SS-1 transmission.

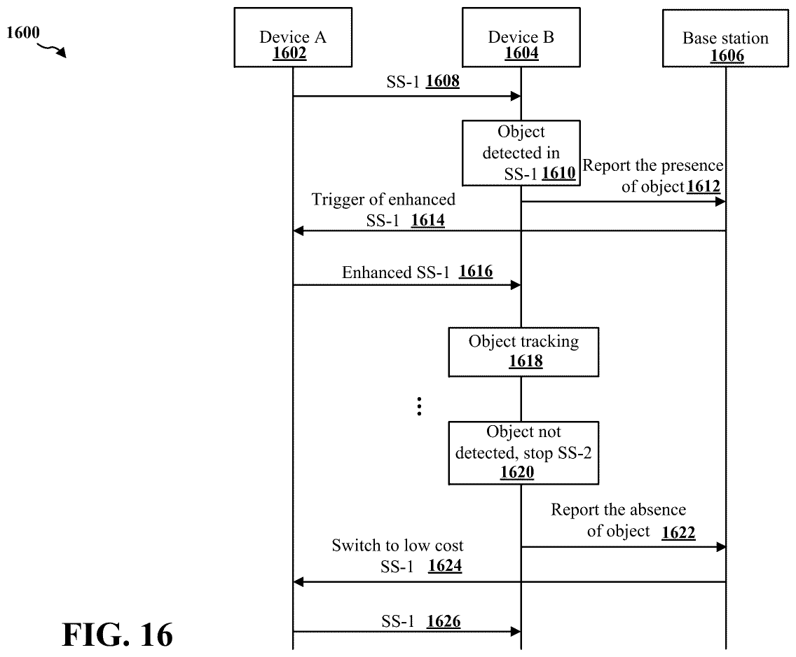

In some aspects with a base station, the network may also be involved in the adaptive sensing procedure performed by two sensing devices. In such a framework, the sensing device reports the detection of object from low-cost sensing signal and lets the base station configure the other device to send enhanced (e.g., denser wider bandwidth, and/or longer duration) sensing signals. FIG. 16 is a diagram 1600 illustrating example communications between devices for sensing. The sensing device A 1602 may transmit sensing signal SS-1 1608 to the sensing device B 1604. In some aspects, low-cost SS-1 is transmitted (e.g., on sparse occasions etc.). On each occasion, the duration may be short if the presence of the object is detected by SS-1. If the mobility and speed of the object are detected, SS-1 duration may have a relatively long duration for micro-Doppler detection. At 1610, the sensing device B 1604 may detect the object within received SS-1 and send a report 1612 to base station 1606. The detection may be based on device B starting to receive SS-1 when the object shows up, or starting to detect a change in amplitude or multipath components in the received SS-1, or starting to detect micro-Doppler in the received SS-1. In some aspects, the base station 1606 may configure sensing device A 1602 to switch to tracking mode (e.g., using trigger 1614). The sensing device A 1602 may transmit enhanced SS-1 1616, e.g., on denser occasions and/or with a long duration on each duration or the like. At 1618, the sensing device B 1604 may carry out sensing computation based on received enhanced SS-1 and track the object. In some aspects, at 1620, the object may leave the detection range of the sensing devices. The device B 1604 may not detect the object in SS-1 anymore at 1620 and device B 1604 may report the absence of the object to the base station at 1622. In some aspects, the base station 1606 may accordingly configure the sensing device A 1602 to switch back to low-cost transmission of SS-1 1626 at 1624. Compared to the framework without a base station, the framework with a base station may save frequency resources that may be otherwise used for SS-2 transmission by device B. However, the framework without a base station may be more suitable for short range sensing with low power sensing signals such that a tight coordination between device A and device B is not used. The framework without a base station may also work for the out-of-coverage scenario.

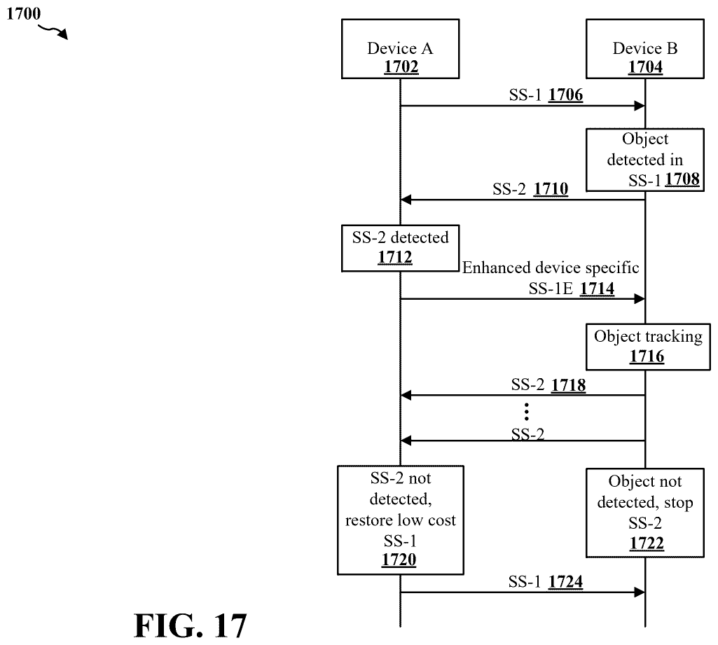

In some aspects, there may be multiple sensing devices are involved in the sensing procedure. In this case, the framework with two sensing devices discussed previously may also apply to each pair of sensing devices if the sensing signal is associated with the transmitter sensing device's identity (i.e., device specific sensing signal). Common sensing signals may be used for the low-cost sensing signal transmission for processing a complexity reduction. FIG. 17 is a diagram 1700 illustrating example communications between devices for sensing. At step 1, sensing device A 1702 may transmit sensing signal SS-1 1706. SS-1 may not be specific to device A. Multiple sensing devices can transmit the same SS-1 on the same occasion (it is understood that not all devices may transmit at the same time). Based on the object detected in SS-1 at 1708, the sensing device B 1704 may start to transmit SS-2 1710. The detection may be claimed when device B starts to receive SS-1, starts to detect a change in amplitude or new multi-path component of the received SS-1, or starts to detect micro-Doppler in the received SS-1. SS-2 may be transmitted with a fixed time offset to the SS-1 occasion. For example, SS-2 may also be low cost, e.g., sparse and with short duration, and may act as an indicator signal. In another example, SS-2 may be an enhanced sensing signal, e.g., dense and with a long duration. Then device A may also carry out the sensing computation based on SS-2. Device B may turn on detection of device specific SS from device A. SS-2 may also be not specific to device B.

At 1712, the sensing device A may detect SS-2 and may switch to a tracking mode. Device A may switch to transmit the enhanced SS-1 1714, e.g., in shorter periodicity, wider bandwidth, narrower beam (potentially with beam sweeping and refinement), with a phase continuity and/or with a long duration on each duration. The enhanced SS-1 1714 may be device specific. The device specific sensing signal may provide additional information about the geometric relationship among the sensing devices that may be useful to better track the object. Device B may start to detect device specific SS-1E when the object shows up. In some aspects, the sensing device B 1704 may carry out a sensing computation and track the object at 1716 (device B may check all possible device specific sensing signals from devices that transmit enhanced sensing signals).

The device B may keep transmitting SS-2 1718. In some aspects, the sensing object may leave the detection range of the sensing devices. The device B may not detect the object in SS-1 anymore and it may stop transmitting SS-2 at 1722. In some aspects, device A may not receive SS-2 anymore at 1720 (or alternatively it may not detect the object in SS-2 when enhanced SS-2 is transmitted) at 1724, and the device A may switch to a low-cost SS-1 1726.

If the object is detected based on SS-1 being received by device B, after the object leaves, SS-2 may disappear even if device B still transmits it. If the object is detected based on micro-Doppler in SS-1 by device B, after the object leaves, SS-2 may still be received by device A (due to direct path or environmental reflection). Device B may turn off the SS-2 transmission. In either case, once device B turns off the SS-2 transmission after the object is gone, device A may know it can switch to a low-cost SS-1 transmission.

In some aspects, the sensing device may report the detection of the object based on a low-cost sensing signal and may let the base station configure the other devices that transmit sensing signals to send enhanced sensing signals, e.g., denser and/or longer duration sensing signals.

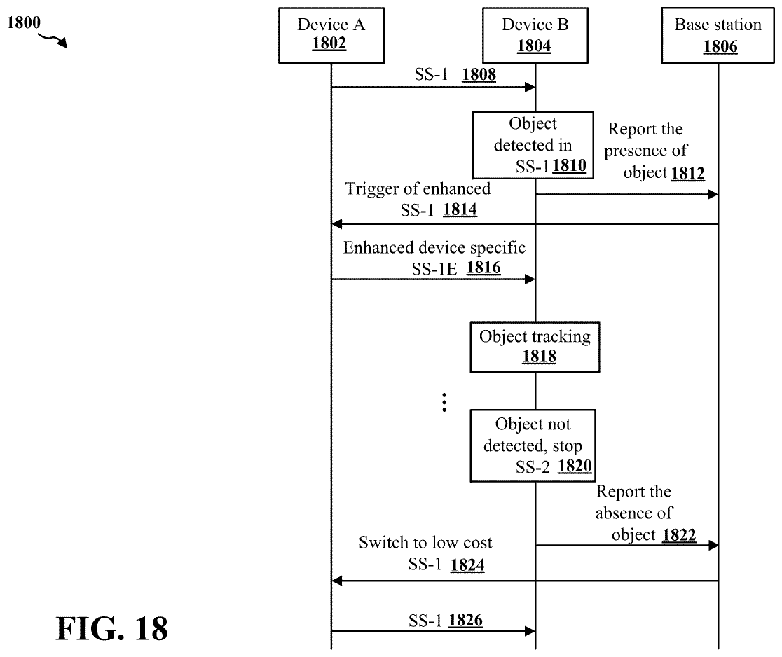

FIG. 18 is a diagram 1800 illustrating example communications between devices for sensing. The sensing device A 1802 may transmit common sensing signal SS-1 1808 (not associated with the transmitter device's identity). In some aspects, low-cost SS-1 is transmitted (e.g., on sparse occasions etc.). On each occasion, the duration may be short if presence of the object is detected by SS-1. If the mobility and speed of the object are detected, SS-1 duration may have a relatively long duration for micro-Doppler detection. At 1810, the sensing device B 1804 may detect the object within received SS-1 and send a report 1812 to base station 1806. The detection may be based on device B starting to receive SS-1 when object shows up, starting to detect change of amplitude or multipath components in the received SS-1, or starting to detect micro-Doppler in the received SS-1. In some aspects, the base station 1806 may configure sensing device A 1802 to switch to tracking mode (e.g., using trigger 1814). The sensing device A 1802 may transmit an enhanced SS-1E 1816, e.g., on denser occasions and/or with long duration on each duration or the like. The enhanced SS-1E 1816 may be specific. At 1818, the sensing device B 1804 may carry out a sensing computation based on a received enhanced SS-1 and track the object. In some aspects, at 1820, the object may leave the detection range of the sensing devices. The device B 1804 may not detect the object in SS-1 anymore at 1820 and device B 1804 may report the absence of object to the base station at 1822. In some aspects, the base station 1806 may accordingly configure the sensing device A 1802 (by transmitting signal 1824) to switch back to a low-cost transmission of SS-1 1826 at 1824.

In some aspects, the network may configure multiple occasions for different sets of sensing devices to transmit the SS-1 signal and let the remaining devices receive SS-1. Pairing of different transmitter devices and receiver devices may be scattered over the entire sensing area to help avoid detection coverage holes in the sensing area. The same devices may be included in more than one set. For example, within each sensing signal transmission period, two occasions may be configured, and two subsets of the sensing devices may be determined as sensing devices that transmit SS-1. Devices in one set may transmit sensing signal SS-1 and devices in the other set may detect the SS-1. More occasions may be configured. This may allow more sensing devices to be paired up to better cover the sensing area. In some aspects, the device specific sensing signal may be associated with the sensing device based on its ID being mapped to the sequence, time domain resource, and/or frequency domain resource of the sensing signal. For all sensing signals, the transmission may have a same configuration at least for the same type of sensing signal (low-cost, enhanced), including: (1) periodicity (low-cost sensing signal may have a periodicity equal to multiple TDD DL/UL pattern duration or multiple SSB periodicity), (2) subcarrier spacing for OFDM based sensing signals, or (3) a basic sequence.

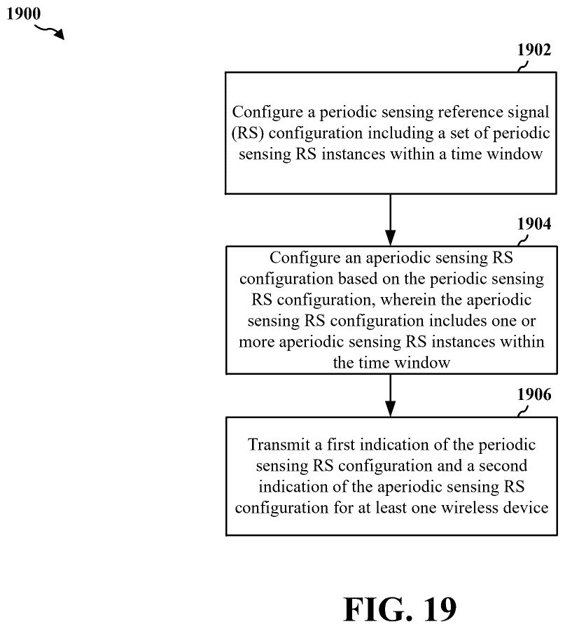

FIG. 19 is a flowchart 1900 of a method of wireless communication. The method may be performed by a network entity (e.g., the base station 102, the UE 104, the network entity 704, the network entity 2302, the apparatus 2304, the network entity 2402).

At 1902, the network entity may configure a periodic sensing RS configuration including a set of periodic sensing RS instances within a time window. For example, the network entity 704 may configure a periodic sensing RS configuration including a set of periodic sensing RS instances within a time window at 706. In some aspects, 1902 may be performed by the RS component 199.

At 1904, the network entity may configure an aperiodic sensing RS configuration based on the periodic sensing RS configuration, where the aperiodic sensing RS configuration includes one or more aperiodic sensing RS instances within the time window. For example, the network entity 704 may configure an aperiodic sensing RS configuration based on the periodic sensing RS configuration at 710, where the aperiodic sensing RS configuration includes one or more aperiodic sensing RS instances within the time window. In some aspects, 1904 may be performed by the RS component 199.

At 1906, the network entity may transmit a first indication of the periodic sensing RS configuration and a second indication of the aperiodic sensing RS configuration for at least one wireless device. For example, the network entity 704 may transmit a first indication of the periodic sensing RS configuration and a second indication (e.g., indication(s) 714) of the aperiodic sensing RS configuration for at least one wireless device. In some aspects, 1906 may be performed by the RS component 199.

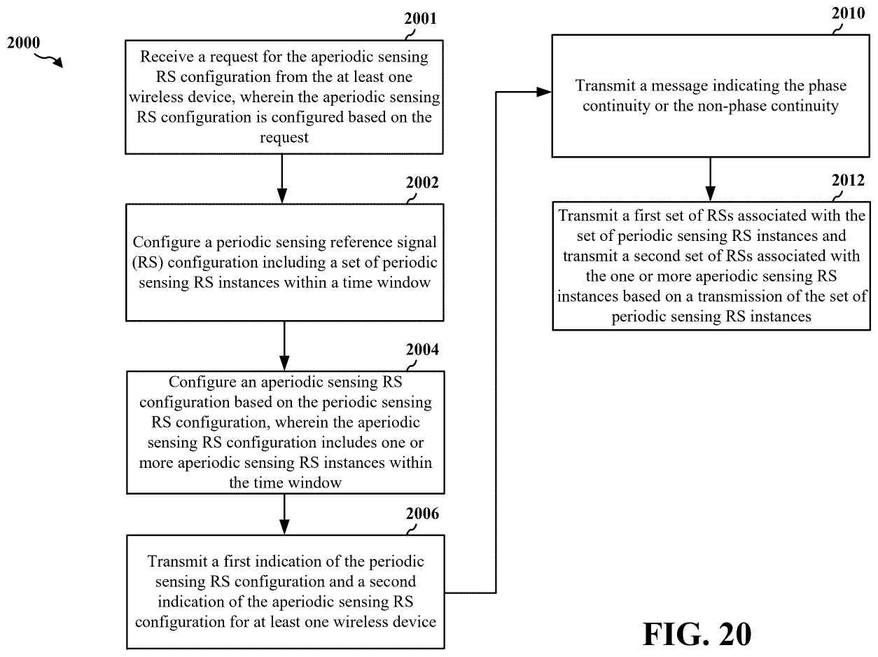

FIG. 20 is a flowchart 2000 of a method of wireless communication. The method may be performed by a network entity (e.g., the base station 102, the UE 104, the network entity 704, the network entity 2302, the apparatus 2304, the network entity 2402).

At 2001, the network entity may receive a request for the aperiodic sensing RS configuration from the at least one wireless device, where the aperiodic sensing RS configuration may be configured based on receiving the request. For example, the network entity 704 may receive a request 708 for the aperiodic sensing RS configuration from the at least one wireless device, where the aperiodic sensing RS configuration may be configured based on receiving the request. In some aspects, 2001 may be performed by the RS component 199. In some aspects, the request may indicate the one or more aperiodic sensing RS instances in an aperiodic resource index. In some aspects, the request may indicate a quantity of sensing instances associated with the one or more aperiodic sensing RS instances without explicitly indicating the one or more aperiodic sensing RS instances.

At 2002, the network entity may configure a periodic sensing RS configuration including a set of periodic sensing RS instances within a time window. For example, the network entity 704 may configure a periodic sensing RS configuration including a set of periodic sensing RS instances within a time window at 706. In some aspects, 2002 may be performed by the RS component 199. In some aspects, the periodic sensing RS configuration may be associated with a periodical pattern, and the periodical pattern may be associated with the one or more aperiodic sensing RS instances. In some aspects, the set of periodic sensing RS instances may be associated with a first channel and the one or more aperiodic sensing RS instances are associated with a second channel, where the first channel may be one of a channel state information reference signal (CSI-RS), a synchronization signal block (SSB), a positioning reference signal (PRS), or a tracking reference signal (TRS), and where the second channel may be another of the CSI-RS, the SSB, the PRS, or the TRS. At 2004, the network entity may configure an aperiodic sensing RS configuration based on the periodic sensing RS configuration, where the aperiodic sensing RS configuration includes one or more aperiodic sensing RS instances within the time window. For example, the network entity 704 may configure an aperiodic sensing RS configuration based on the periodic sensing RS configuration at 710, where the aperiodic sensing RS configuration includes one or more aperiodic sensing RS instances within the time window. In some aspects, 2004 may be performed by the RS component 199.

At 2006, the network entity may transmit a first indication of the periodic sensing RS configuration and a second indication of the aperiodic sensing RS configuration for at least one wireless device. For example, the network entity 704 may transmit a first indication of the periodic sensing RS configuration and a second indication (e.g., indication(s) 714) of the aperiodic sensing RS configuration for at least one wireless device. In some aspects, 2006 may be performed by the RS component 199. In some aspects, the second indication may be transmitted via DCI, and where the first indication may be either equivalent to or different from the second indication. In some aspects, the periodic sensing RS configuration may further include a second set of periodic sensing RS instances within the time window, where the set of periodic sensing RS instances and the second set of periodic sensing RS instances are associated with Doppler estimation, and where a phase continuity or a non-phase continuity exists between the set of periodic sensing RS instances and the second set of periodic sensing RS instances.

At 2010, the network entity may transmit a first set of RSs associated with the set of periodic sensing RS instances and transmit a second set of RSs associated with the one or more aperiodic sensing RS instances based on a transmission of the set of periodic sensing RS instances. For example, the network entity 704 may transmit a first set of RSs associated with the set of periodic sensing RS instances (e.g., 716) and transmit a second set of RSs associated with the one or more aperiodic sensing RS instances (e.g., 718) based on a transmission of the set of periodic sensing RS instances. In some aspects, 2010 may be performed by the RS component 199. In some aspects, the set of periodic sensing RS instances and the one or more aperiodic sensing RS instances are associated with a phase continuity and a same Doppler estimation based on the phase continuity. In some aspects, the set of periodic sensing RS instances and the one or more aperiodic sensing RS instances are quasi-co-located (QCLed) based on a QCL format indicating the phase continuity.

At 2012, the network entity may transmit a message indicating the phase continuity or the non-phase continuity. For example, the network entity 704 may transmit a message 712 indicating the phase continuity or the non-phase continuity. In some aspects, 2012 may be performed by the RS component 199.

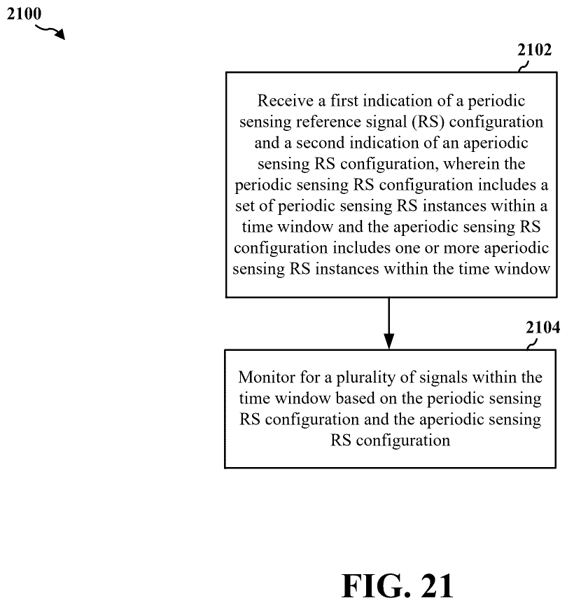

FIG. 21 is a flowchart 2100 of a method of wireless communication. The method may be performed by a wireless device (e.g., the base station 102, the UE 104, the wireless device 702, the network entity 2302, the apparatus 2304, the network entity 2402).

At 2102, the device may receive a first indication of a periodic sensing RS configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. For example, the device 702 may receive a first indication of a periodic sensing RS configuration and a second indication of an aperiodic sensing RS configuration (e.g., indications 714), where the periodic sensing RS configuration includes a set of periodic sensing RS instances within a time window and the aperiodic sensing RS configuration includes one or more aperiodic sensing RS instances within the time window. In some aspects, 2102 may be performed by the RS component 198. In some aspects, the second indication may be received via DCI, and where the first indication may be either equivalent to or different from the second indication.

At 2104, the device may monitor for a plurality of signals within the time window based on the periodic sensing RS configuration and the aperiodic sensing RS configuration. For example, the device 702 may monitor (e.g., at 720) for a plurality of signals within the time window based on the periodic sensing RS configuration and the aperiodic sensing RS configuration. In some aspects, 2104 may be performed by the RS component 198.

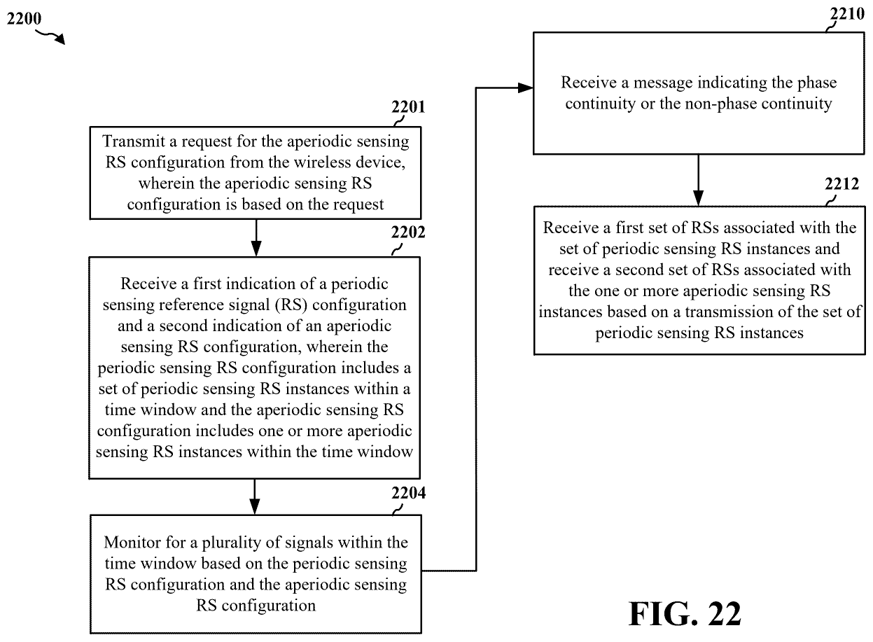

FIG. 22 is a flowchart 2200 of a method of wireless communication. The method may be performed by a wireless device (e.g., the base station 102, the UE 104, the wireless device 702, the network entity 2302, the apparatus 2304, the network entity 2402).

At 2201, the device may transmit a request for the aperiodic sensing RS configuration from the wireless device, where the aperiodic sensing RS configuration may be based on the request. For example, the wireless device 702 may transmit a request 708 for the aperiodic sensing RS configuration, where the aperiodic sensing RS configuration may be based on the request. In some aspects, 2201 may be performed by the RS component 198. In some aspects, the request may indicate the one or more aperiodic sensing RS instances in an aperiodic resource index. In some aspects, the request may indicate a quantity of sensing instances associated with the one or more aperiodic sensing RS instances without explicitly indicating the one or more aperiodic sensing RS instances.

At 2202, the device may receive a first indication of a periodic sensing RS configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. For example, the device 702 may receive a first indication of a periodic sensing RS configuration and a second indication of an aperiodic sensing RS configuration (e.g., indications 714), where the periodic sensing RS configuration includes a set of periodic sensing RS instances within a time window and the aperiodic sensing RS configuration includes one or more aperiodic sensing RS instances within the time window. In some aspects, 2202 may be performed by the RS component 198. In some aspects, the periodic sensing RS configuration may be associated with a periodical pattern, and the periodical pattern may be associated with the one or more aperiodic sensing RS instances. In some aspects, the periodic sensing RS configuration may further include a second set of periodic sensing RS instances within the time window, where the set of periodic sensing RS instances and the second set of periodic sensing RS instances are associated with Doppler estimation, and where a phase continuity or a non-phase continuity exists between the set of periodic sensing RS instances and the second set of periodic sensing RS instances. In some aspects, the set of periodic sensing RS instances may be associated with a first channel and the one or more aperiodic sensing RS instances are associated with a second channel, where the first channel may be one of a channel state information reference signal (CSI-RS), a synchronization signal block (SSB), a positioning reference signal (PRS), or a tracking reference signal (TRS), and where the second channel may be another of the CSI-RS, the SSB, the PRS, or the TRS.

At 2204, the device may monitor for a plurality of signals within the time window based on the periodic sensing RS configuration and the aperiodic sensing RS configuration. For example, the device 702 may monitor (e.g., at 720) for a plurality of signals within the time window based on the periodic sensing RS configuration and the aperiodic sensing RS configuration. In some aspects, 2204 may be performed by the RS component 198.

At 2210, the device may receive a first set of RSs associated with the set of periodic sensing RS instances and receive a second set of RSs associated with the one or more aperiodic sensing RS instances based on a transmission of the set of periodic sensing RS instances, where the plurality of signals includes the first set of RSs and the second set of RSs. For example, the wireless device 702 may receive a first set of RSs associated with the set of periodic sensing RS instances (e.g., 716) and receive a second set of RSs associated with the one or more aperiodic sensing RS instances based on a transmission of the set of periodic sensing RS instances (e.g., 718). In some aspects, 2210 may be performed by the RS component 198. In some aspects, the set of periodic sensing RS instances and the one or more aperiodic sensing RS instances are associated with a phase continuity and a same Doppler estimation based on the phase continuity. In some aspects, the set of periodic sensing RS instances and the one or more aperiodic sensing RS instances are quasi-co-located (QCLed) based on a QCL format indicating the phase continuity.

At 2212, the device may receive a message indicating the phase continuity or the non-phase continuity. For example, the wireless device 702 may receive a message 712 indicating the phase continuity or the non-phase continuity. In some aspects, 2212 may be performed by the RS component 198.

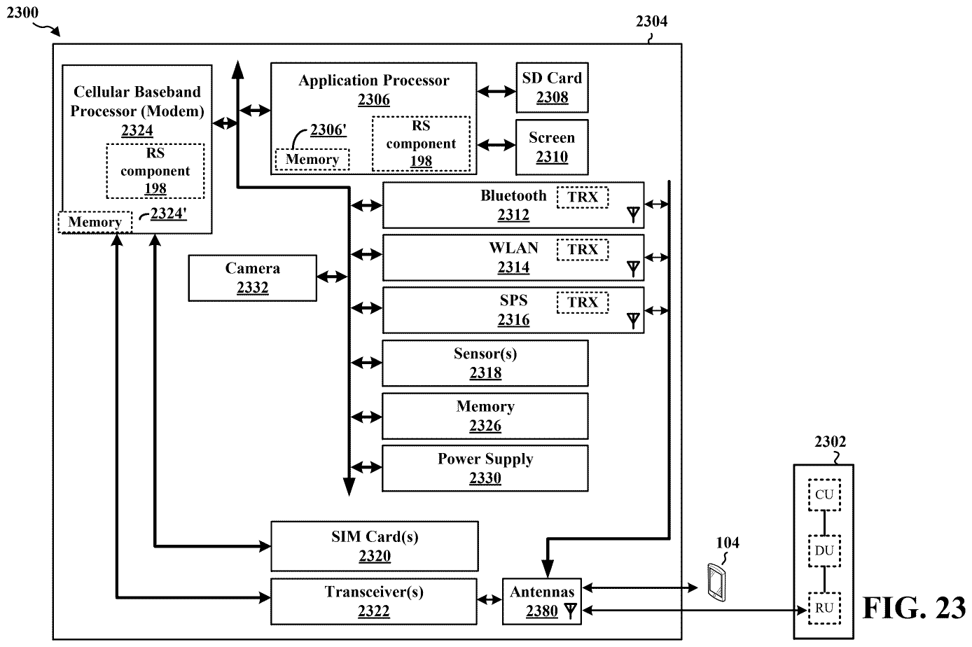

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include a cellular baseband processor 2324 (also referred to as a modem) coupled to one or more transceivers 2322 (e.g., cellular RF transceiver). The cellular baseband processor 2324 may include on-chip memory 2324′. In some aspects, the apparatus 2304 may further include one or more subscriber identity modules (SIM) cards 2320 and an application processor 2306 coupled to a secure digital (SD) card 2308 and a screen 2310. The application processor 2306 may include on-chip memory 2306′. In some aspects, the apparatus 2304 may further include a Bluetooth module 2312, a WLAN module 2314, a satellite system module 2316 (e.g., GNSS module), one or more sensor modules 2318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2326, a power supply 2330, and/or a camera 2332. The Bluetooth module 2312, the WLAN module 2314, and the satellite system module 2316 may include an on-chip transceiver (TRX)/receiver (RX). The cellular baseband processor 2324 communicates through the transceiver(s) 2322 via one or more antennas 2380 with the UE 104 and/or with an RU associated with a network entity 2302. The cellular baseband processor 2324 and the application processor 2306 may each include a computer-readable medium/memory 2324′, 2306′, respectively. The additional memory modules 2326 may also be considered a computer-readable medium/memory. Each computer-readable medium/memory 2324′, 2306′, 2326 may be non-transitory. The cellular baseband processor 2324 and the application processor 2306 are each responsible for general processing, including the execution of software stored on the computer-readable medium/memory. The software, when executed by the cellular baseband processor 2324/application processor 2306, causes the cellular baseband processor 2324/application processor 2306 to perform the various functions described herein. The computer-readable medium/memory may also be used for storing data that is manipulated by the cellular baseband processor 2324/application processor 2306 when executing software. The cellular baseband processor 2324/application processor 2306 may be a component of the UE 350 and may include the memory 360 and/or at least one of the TX processor 368, the RX processor 356, and the controller/processor 359. In one configuration, the apparatus 2304 may be a processor chip (modem and/or application) and include just the cellular baseband processor 2324 and/or the application processor 2306, and in another configuration, the apparatus 2304 may be the entire UE (e.g., see 350 of FIG. 3) and include the additional modules of the apparatus 2304.

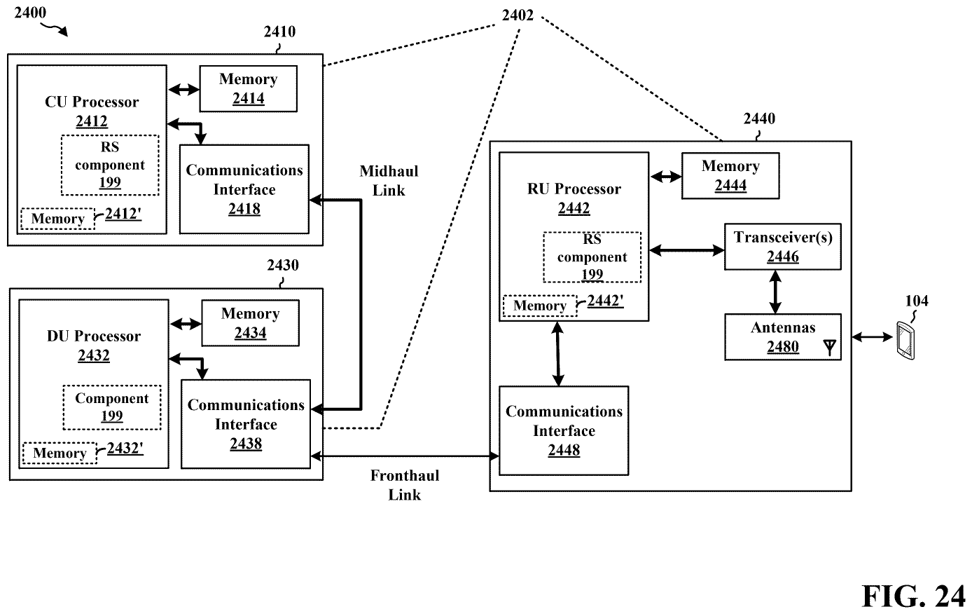

As discussed herein, the RS component 198 may be configured to receive a first indication of a periodic sensing reference signal (RS) configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. In some aspects, the RS component 198 may be further configured to monitor for a plurality of signals within the time window based on the periodic sensing RS configuration and the aperiodic sensing RS configuration. The RS component 198 may be within the cellular baseband processor 2324, the application processor 2306, or both the cellular baseband processor 2324 and the application processor 2306. The RS component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2304 may include a variety of components configured for various functions. In one configuration, the apparatus 2304, and in particular the cellular baseband processor 2324 and/or the application processor 2306, includes means for receiving a first indication of a periodic sensing RS configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window. In some aspects, the apparatus 2304 may further include means for monitoring for a plurality of signals within the time window based on the periodic sensing RS configuration and the aperiodic sensing RS configuration. In some aspects, the apparatus 2304 may further include means for transmitting a request for the aperiodic sensing RS configuration from the wireless device, where the aperiodic sensing RS configuration may be based on the request. In some aspects, the apparatus 2304 may further include means for receiving a first set of RSs associated with the set of periodic sensing RS instances. In some aspects, the apparatus 2304 may further include means for receiving a second set of RSs associated with the one or more aperiodic sensing RS instances based on a transmission of the set of periodic sensing RS instances, where the plurality of signals includes the first set of RSs and the second set of RSs. In some aspects, the apparatus 2304 may further include means for receiving a message indicating the phase continuity or the non-phase continuity. The means may be the RS component 198 of the apparatus 2304 configured to perform the functions recited by the means. As described herein, the apparatus 2304 may include the TX processor 368, the RX processor 356, and the controller/processor 359. As such, in one configuration, the means may be the TX processor 368, the RX processor 356, and/or the controller/processor 359 configured to perform the functions recited by the means. FIG. 24 is a diagram 2400 illustrating an example of a hardware implementation for a network entity 2402. The network entity 2402 may be a BS, a component of a BS, or may implement BS functionality. The network entity 2402 may include at least one of a CU 2410, a DU 2430, or an RU 2440. For example, depending on the layer functionality handled by the component 199, the network entity 2402 may include the CU 2410; both the CU 2410 and the DU 2430; each of the CU 2410, the DU 2430, and the RU 2440; the DU 2430; both the DU 2430 and the RU 2440; or the RU 2440. The CU 2410 may include a CU processor 2412. The CU processor 2412 may include on-chip memory 2412′. In some aspects, the CU 2410 may further include additional memory modules 2414 and a communications interface 2418. The CU 2410 communicates with the DU 2430 through a midhaul link, such as an F1 interface. The DU 2430 may include a DU processor 2432. The DU processor 2432 may include on-chip memory 2432′. In some aspects, the DU 2430 may further include additional memory modules 2434 and a communications interface 2438. The DU 2430 communicates with the RU 2440 through a fronthaul link. The RU 2440 may include an RU processor 2442. The RU processor 2442 may include on-chip memory 2442′. In some aspects, the RU 2440 may further include additional memory modules 2444, one or more transceivers 2446, antennas 2480, and a communications interface 2448.

The RU 2440 communicates with the UE 104. The on-chip memory 2412′, 2432′, 2442′ and the additional memory modules 2414, 2434, 2444 may each be considered a computer-readable medium/memory. Each computer-readable medium/memory may be non-transitory. Each of the processors 2412, 2432, 2442 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the RS component 199 may be configured to configure a periodic sensing reference signal (RS) configuration including a set of periodic sensing RS instances within a time window. In some aspects, the RS component 199 may be further configured to configure an aperiodic sensing RS configuration based on the periodic sensing RS configuration, where the aperiodic sensing RS configuration includes one or more aperiodic sensing RS instances within the time window. In some aspects, the RS component 199 may be further configured to transmit a first indication of the periodic sensing RS configuration and a second indication of the aperiodic sensing RS configuration for at least one wireless device. The RS component 199 may be within one or more processors of one or more of the CU 2410, DU 2430, and the RU 2440. The RS component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2402 may include a variety of components configured for various functions. In one configuration, the network entity 2402 includes means for configuring a periodic sensing RS configuration including a set of periodic sensing RS instances within a time window. In some aspects, the network entity 2402 may further include means for configuring an aperiodic sensing RS configuration based on the periodic sensing RS configuration, where the aperiodic sensing RS configuration includes one or more aperiodic sensing RS instances within the time window. In some aspects, the network entity 2402 may further include means for transmitting a first indication of the periodic sensing RS configuration and a second indication of the aperiodic sensing RS configuration for at least one wireless device. In some aspects, the network entity 2402 may further include means for receiving a request for the aperiodic sensing RS configuration from the at least one wireless device, where the aperiodic sensing RS configuration may be configured based on the request. In some aspects, the network entity 2402 may further include means for transmitting a first set of RSs associated with the set of periodic sensing RS instances. In some aspects, the network entity 2402 may further include means for transmitting a second set of RSs associated with the one or more aperiodic sensing RS instances based on a transmission of the set of periodic sensing RS instances. In some aspects, the network entity 2402 may further include means for transmitting a message indicating the phase continuity or the non-phase continuity. The means may be the RS component 199 of the network entity 2402 configured to perform the functions recited by the means. As described herein, the network entity 2402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a network entity, including: configuring a periodic sensing RS configuration including a set of periodic sensing RS instances within a time window; configuring an aperiodic sensing RS configuration based on the periodic sensing RS configuration, where the aperiodic sensing RS configuration includes one or more aperiodic sensing RS instances within the time window; and transmitting a first indication of the periodic sensing RS configuration and a second indication of the aperiodic sensing RS configuration for at least one wireless device.

Aspect 2 is the method of any of aspects 1, where the second indication may be transmitted via DCI, and where the first indication may be either equivalent to or different from the second indication.

Aspect 3 is the method of any of aspects 1-2, further including: receiving a request for the aperiodic sensing RS configuration from the at least one wireless device, where the aperiodic sensing RS configuration may be configured based on receiving the request.

Aspect 4 is the method of any of aspects 1-3, where the request may indicate the one or more aperiodic sensing RS instances in an aperiodic resource index.

Aspect 5 is the method of any of aspects 1-3, where the request may indicate a quantity of sensing instances associated with the one or more aperiodic sensing RS instances without explicitly indicating the one or more aperiodic sensing RS instances.

Aspect 6 is the method of any of aspects 1-5, where the periodic sensing RS configuration may be associated with a periodical pattern, and the periodical pattern may be associated with the one or more aperiodic sensing RS instances.

Aspect 7 is the method of any of aspects 1-6, further including: transmitting a first set of RSs associated with the set of periodic sensing RS instances; and transmitting a second set of RSs associated with the one or more aperiodic sensing RS instances based on a transmission of the set of periodic sensing RS instances.

Aspect 8 is the method of any of aspects 1-7, where the set of periodic sensing RS instances and the one or more aperiodic sensing RS instances are associated with a phase continuity and a same Doppler estimation based on the phase continuity.

Aspect 9 is the method of any of aspects 1-8, where the set of periodic sensing RS instances and the one or more aperiodic sensing RS instances are quasi-co-located (QCL'ed) based on a QCL format indicating the phase continuity.

Aspect 10 is the method of any of aspects 1-9, further including: transmitting a message indicating the phase continuity.

Aspect 11 is the method of any of aspects 1-10, where the periodic sensing RS configuration may further include a second set of periodic sensing RS instances within the time window, where the set of periodic sensing RS instances and the second set of periodic sensing RS instances are associated with Doppler estimation, and where a phase continuity or a non-phase continuity exists between the set of periodic sensing RS instances and the second set of periodic sensing RS instances, and further including: transmitting a message indicating the phase continuity or the non-phase continuity.

Aspect 12 is the method of any of aspects 1-11, where the set of periodic sensing RS instances may be associated with a first channel and the one or more aperiodic sensing RS instances are associated with a second channel, where the first channel may be one of a channel state information reference signal (CSI-RS), a synchronization signal block (SSB), a positioning reference signal (PRS), or a tracking reference signal (TRS), and where the second channel may be another of the CSI-RS, the SSB, the PRS, or the TRS.

Aspect 13 is the method of any of aspects 1-12, where the at least one wireless device includes at least one of a sensing receive (Rx) device or a sensing transmit (Tx) device.

Aspect 14 is the method of any of aspects 1-13, where the sensing Rx device may be a user equipment (UE), a component of the UE, a base station, or a component of the base station, and where the sensing Tx device may be the UE, the component of the UE, the base station, or the component of the base station.

Aspect 15 is a method of wireless communication at a wireless device, including: receiving a first indication of a periodic sensing RS configuration and a second indication of an aperiodic sensing RS configuration, where the periodic sensing RS configuration includes a set of periodic sensing RS instances within a time window and the aperiodic sensing RS configuration includes one or more aperiodic sensing RS instances within the time window; and monitoring for a plurality of signals within the time window based on the periodic sensing RS configuration and the aperiodic sensing RS configuration.

Aspect 16 is the method of aspect 15, where the second indication may be received via DCI, and where the first indication may be either equivalent to or different from the second indication.

Aspect 17 is the method of any of aspects 15-16, further including: transmitting a request for the aperiodic sensing RS configuration from the wireless device, where the aperiodic sensing RS configuration may be based on the request.

Aspect 18 is the method of any of aspects 15-17, where the request may indicate the one or more aperiodic sensing RS instances in an aperiodic resource index.

Aspect 19 is the method of any of aspects 15-17, where the request may indicate a quantity of sensing instances associated with the one or more aperiodic sensing RS instances without explicitly indicating the one or more aperiodic sensing RS instances.

Aspect 20 is the method of any of aspects 15-19, where the periodic sensing RS configuration may be associated with a periodical pattern, and the periodical pattern may be associated with the one or more aperiodic sensing RS instances.

Aspect 21 is the method of any of aspects 15, further including: receiving a first set of RSs associated with the set of periodic sensing RS instances; and receiving a second set of RSs associated with the one or more aperiodic sensing RS instances based on a transmission of the set of periodic sensing RS instances, where the plurality of signals include the first set of RSs and the second set of RSs.

Aspect 22 is the method of any of aspects 15-21, where the set of periodic sensing RS instances and the one or more aperiodic sensing RS instances are associated with a phase continuity.

Aspect 23 is the method of any of aspects 15-22, where the set of periodic sensing RS instances and the one or more aperiodic sensing RS instances are quasi-co-located (QCL'ed) based on a QCL format indicating the phase continuity.

Aspect 24 is the method of any of aspects 15-23, further including: receiving a message indicating the phase continuity and a same Doppler estimation based on the phase continuity.

Aspect 25 is the method of any of aspects 15-24, where the periodic sensing RS configuration may further include a second set of periodic sensing RS instances within the time window, where the set of periodic sensing RS instances and the second set of periodic sensing RS instances are associated with Doppler estimation, and where a phase continuity or a non-phase continuity exists between the set of periodic sensing RS instances and the second set of periodic sensing RS instances, and further including: receiving a message indicating the phase continuity or the non-phase continuity.

Aspect 26 is the method of any of aspects 15-25, where the set of periodic sensing RS instances may be associated with a first channel and the one or more aperiodic sensing RS instances are associated with a second channel, where the first channel may be one of a channel state information reference signal (CSI-RS), a synchronization signal block (SSB), a positioning reference signal (PRS), or a tracking reference signal (TRS), and where the second channel may be another of the CSI-RS, the SSB, the PRS, or the TRS.

Aspect 27 is the method of any of aspects 15-26, where the wireless device corresponds to at least one of a sensing receive (Rx) device or a sensing transmit (Tx) device.

Aspect 28 is the method of any of aspects 15-27, where the sensing Rx device may be a user equipment (UE), a component of the UE, a base station, or a component of the base station, and where the sensing Tx device may be the UE, the component of the UE, the base station, or the component of the base station.

Aspect 29 is an apparatus for wireless communication at a device including a memory and at least one processor coupled to the memory and, based at least in part on information stored in the memory, configured to perform a method in accordance with any of aspects 1-14. The apparatus may include at least one of a transceiver or an antenna coupled to the at least one processor.

Aspect 30 is an apparatus for wireless communication, including means for performing a method in accordance with any of aspects 1-14.

Aspect 31 is a non-transitory computer-readable medium including instructions that, when executed by an apparatus, cause the apparatus to perform a method in accordance with any of aspects 1-14.

Aspect 32 is an apparatus for wireless communication at a device including a memory and at least one processor coupled to the memory and, based at least in part on information stored in the memory, configured to perform a method in accordance with any of aspects 15-28. The apparatus may include at least one of a transceiver or an antenna coupled to the at least one processor.

Aspect 33 is an apparatus for wireless communication, including means for performing a method in accordance with any of aspects 15-28.

Aspect 34 is a non-transitory computer-readable medium including instructions that, when executed by an apparatus, cause the apparatus to perform a method in accordance with any of aspects 15-28.

What is claimed is:

1. An apparatus for wireless communication at a network entity, comprising:
a memory; and
at least one processor coupled to the memory, wherein the at least one processor is configured to:
configure a periodic sensing reference signal (RS) configuration including a set of periodic sensing RS instances within a time window;
configure an aperiodic sensing RS configuration based on the periodic sensing RS configuration, wherein the aperiodic sensing RS configuration includes one or more aperiodic sensing RS instances within the time window; and
transmit a first indication of the periodic sensing RS configuration and a second indication of the aperiodic sensing RS configuration for at least one wireless device.

2. The apparatus of claim 1, wherein the second indication is transmitted via downlink control information (DCI), and wherein the first indication is either equivalent to or different from the second indication.

3. The apparatus of claim 1, wherein the at least one processor is configured to:
receive a request for the aperiodic sensing RS configuration from the at least one wireless device, wherein the aperiodic sensing RS configuration is configured based on receiving the request.

4. The apparatus of claim 3, wherein the request indicates the one or more aperiodic sensing RS instances in an aperiodic resource index.

5. The apparatus of claim 3, wherein the request indicates a quantity of sensing instances associated with the one or more aperiodic sensing RS instances without explicitly indicating the one or more aperiodic sensing RS instances.

6. The apparatus of claim 1, wherein the periodic sensing RS configuration is associated with a periodical pattern, and the periodical pattern is associated with the one or more aperiodic sensing RS instances.

7. The apparatus of claim 1, wherein the at least one processor is configured to:
transmit a first set of RSs associated with the set of periodic sensing RS instances; and
transmit a second set of RSs associated with the one or more aperiodic sensing RS instances based on a transmission of the set of periodic sensing RS instances.

8. The apparatus of claim 1, wherein the set of periodic sensing RS instances and the one or more aperiodic sensing RS instances are associated with a phase continuity and a same Doppler estimation based on the phase continuity.

9. The apparatus of claim 8, wherein the set of periodic sensing RS instances and the one or more aperiodic sensing RS instances are quasi-co-located (QCLed) based on a QCL format indicating the phase continuity.

10. The apparatus of claim 8, wherein the at least one processor is further configured to:
transmit a message indicating the phase continuity.

11. The apparatus of claim 1, wherein the periodic sensing RS configuration further includes a second set of periodic sensing RS instances within the time window, wherein the set of periodic sensing RS instances and the second set of periodic sensing RS instances are associated with Doppler estimation, and wherein a phase continuity or a non-phase continuity exists between the set of periodic sensing RS instances and the second set of periodic sensing RS instances, and wherein the at least one processor is further configured to:
transmit a message indicating the phase continuity or the non-phase continuity.

12. The apparatus of claim 1, wherein the set of periodic sensing RS instances is associated with a first channel and the one or more aperiodic sensing RS instances are associated with a second channel, wherein the first channel is one of a channel state information reference signal (CSI-RS), a synchronization signal block (SSB), a positioning reference signal (PRS), or a tracking reference signal (TRS), and wherein the second channel is another of the CSI-RS, the SSB, the PRS, or the TRS.

13. The apparatus of claim 1, further comprising a transceiver or an antenna coupled to the at least one processor, and wherein the at least one wireless device includes at least one of a sensing receive (Rx) device or a sensing transmit (Tx) device.

14. The apparatus of claim 13, wherein the sensing Rx device is a user equipment (UE), a first component of the UE, a base station, or a second component of the base station, and wherein the sensing Tx device is the UE, the first component of the UE, the base station, or the second component of the base station.

15. An apparatus for wireless communication at a wireless device, comprising:
a memory; and
at least one processor coupled to the memory, wherein the at least one processor is configured to:
receive a first indication of a periodic sensing reference signal (RS) configuration and a second indication of an aperiodic sensing RS configuration, wherein the periodic sensing RS configuration includes a set of periodic sensing RS instances within a time window and the aperiodic sensing RS configuration includes one or more aperiodic sensing RS instances within the time window; and
monitor for a plurality of signals within the time window based on the periodic sensing RS configuration and the aperiodic sensing RS configuration.

16. The apparatus of claim 15, wherein the second indication is received via downlink control information (DCI), and wherein the first indication is either equivalent to or different from the second indication.

17. The apparatus of claim 15, wherein the at least one processor is configured to:
transmit a request for the aperiodic sensing RS configuration, wherein the aperiodic sensing RS configuration is based on the request.

18. The apparatus of claim 17, wherein the request indicates the one or more aperiodic sensing RS instances in an aperiodic resource index.

19. The apparatus of claim 17, wherein the request indicates a quantity of sensing instances associated with the one or more aperiodic sensing RS instances without explicitly indicating the one or more aperiodic sensing RS instances.

20. The apparatus of claim 15, wherein the periodic sensing RS configuration is associated with a periodical pattern, and the periodical pattern is associated with the one or more aperiodic sensing RS instances.

21. The apparatus of claim 15, wherein the at least one processor is configured to:
receive a first set of RSs associated with the set of periodic sensing RS instances; and
receive a second set of RSs associated with the one or more aperiodic sensing RS instances based on a transmission of the set of periodic sensing RS instances, wherein the plurality of signals comprises the first set of RSs and the second set of RSs.

22. The apparatus of claim 15, wherein the set of periodic sensing RS instances and the one or more aperiodic sensing RS instances are associated with a phase continuity and a same Doppler estimation based on the phase continuity.

23. The apparatus of claim 22, wherein the set of periodic sensing RS instances and the one or more aperiodic sensing RS instances are quasi-co-located (QCLed) based on a QCL format indicating the phase continuity.

24. The apparatus of claim 22, wherein the at least one processor is further configured to:
receive a message indicating the phase continuity.

25. The apparatus of claim 15, wherein the periodic sensing RS configuration further includes a second set of periodic sensing RS instances within the time window, wherein the set of periodic sensing RS instances and the second set of periodic sensing RS instances are associated with Doppler estimation, and wherein a phase continuity or a non-phase continuity exists between the set of periodic sensing RS instances and the second set of periodic sensing RS instances, and wherein the at least one processor is further configured to:
receive a message indicating the phase continuity or the non-phase continuity.

26. The apparatus of claim 15, wherein the set of periodic sensing RS instances is associated with a first channel and the one or more aperiodic sensing RS instances are associated with a second channel, wherein the first channel is one of a channel state information reference signal (CSI-RS), a synchronization signal block (SSB), a positioning reference signal (PRS), or a tracking reference signal (TRS), and wherein the second channel is another of the CSI-RS, the SSB, the PRS, or the TRS.

27. The apparatus of claim 15, further comprising a transceiver or an antenna coupled to the at least one processor, and wherein the wireless device corresponds to at least one of a sensing receive (Rx) device or a sensing transmit (Tx) device.

28. The apparatus of claim 27, wherein the sensing Rx device is a user equipment (UE), a first component of the UE, a base station, or a second component of the base station, and wherein the sensing Tx device is the UE, the first component of the UE, the base station, or the second component of the base station.

29. A method of wireless communication at a network entity, comprising:
configuring a periodic sensing reference signal (RS) configuration including a set of periodic sensing RS instances within a time window;
configuring an aperiodic sensing RS configuration based on the periodic sensing RS configuration, wherein the aperiodic sensing RS configuration includes one or more aperiodic sensing RS instances within the time window; and
transmitting a first indication of the periodic sensing RS configuration and a second indication of the aperiodic sensing RS configuration for at least one wireless device.

30. A method of wireless communication at a wireless device, comprising:
receiving a first indication of a periodic sensing reference signal (RS) configuration and a second indication of an aperiodic sensing RS configuration, wherein the periodic sensing RS configuration includes a set of periodic sensing RS instances within a time window and the aperiodic sensing RS configuration includes one or more aperiodic sensing RS instances within the time window; and
monitoring for a plurality of signals within the time window based on the periodic sensing RS configuration and the aperiodic sensing RS configuration.
